(19) United States
(12) Patent Application Publication
(10) Pub. No.: US 2024/0298227 A1
(43) Pub. Date: Sep. 5, 2024

(54) METHODS FOR COMMUNICATION, TERMINAL DEVICE, NETWORK DEVICE, AND COMPUTER READABLE MEDIA

(71) Applicant: NEC CORPORATION, Tokyo (JP)

(72) Inventors: Da WANG, Beijing (CN); Gang WANG, Beijing (CN)

(73) Assignee: NEC CORPORATION, Tokyo (JP)

(21) Appl. No.: 18/270,814

(22) PCT Filed: Jan. 5, 2021
(86) PCT No.: PCT/CN2021/070366

§ 371 Date: Jul. 3, 2023

(51) Int. Cl. H04W 36/00; H04W 24/10

(52) U.S. Cl. CPC H04W 36/00833; H04W 24/10

(57) ABSTRACT

Embodiments of the present disclosure provide a solution for supporting a successful handover report. In a method for communication, a terminal device receives a report configuration from a first network device providing a first cell. The report configuration indicates whether a successful handover report is to be generated for a handover of the terminal device from the first cell to a second cell of a second network device. Then, the terminal device applies the report configuration during performing of the handover. Through the embodiments of the present disclosure, the terminal device may be limited to reporting a successful handover report if the source network device considers the successful handover report as necessary, thereby saving the processing resources and communication resources for the potentially unnecessary successful handover reports.

### FIELD

Embodiments of the present disclosure generally relate to the field of communication, and more particularly, to a solution for supporting a successful handover report.

### BACKGROUND

5G New Radio (NR) is the global standard for a unified and more capable 5G wireless air interface. 5G enables a new kind of network that is designed to connect virtually everyone and everything together including machines, objects, and devices. In the 3rd Generation Partnership Project (3GPP) Release 17 (Rel-17) Work Item Description (WID) Enhancement of data collection for Self-Optimizing Networks (SON)/Minimization of drive tests (MDT) in NR, the objectives for SON feature are the following: support of data collection for SON features, including Coverage and Capacity Optimization (CCO), inter-system inter-radio access technology (RAT) energy saving, inter-system load balancing, 2-step Random Access Channel (RACH) optimization, mobility enhancement optimization, and leftovers of Rel-16 SON/MDT Work Item (WI), for example, successful handover reports.

With regard to the successful handover reports, it is identified that the Mobility Robustness Optimization (MRO) function in NR could be enhanced to provide a more robust mobility via reporting failure events observed during successful handovers. A solution to this problem is to configure User Equipment (UE) to compile a report associated to a successful handover comprising a set of measurements collected during the handover phase, such as a measurement at the handover trigger, a measurement at the end of handover execution, a measurement after handover execution, or the like. However, generating of such a report for each successful handover would introduce unnecessary waste of resources.

### SUMMARY

In general, embodiments of the present disclosure provide a solution for supporting a successful handover report.

In a first aspect, there is provided a method for communication. The method comprises receiving, at a terminal device, a report configuration from a first network device providing a first cell. The report configuration indicates whether a successful handover report is to be generated for a handover of the terminal device from the first cell to a second cell of a second network device. The method also comprises applying the report configuration during performing of the handover.

In a second aspect, there is provided a method for communication. The method comprises transmitting, at a first network device providing a first cell, a report configuration to a terminal device in the first cell. The report configuration indicates whether a successful handover report is to be generated for a handover of the terminal device from the first cell to a second cell of a second network device.

In a third aspect, there is provided a method for communication. The method comprises receiving, at a second network device from a first network device, a handover request message for a handover of a terminal device from a first cell of the first network device to a second cell of the second network device. The handover request message contains a report configuration indicating whether a successful handover report is to be generated for the handover. The method also comprises generating a first message for causing the terminal device to perform the handover and for indicating the report configuration. The method further comprises transmitting the first message to the first network device.

In a fourth aspect, there is provided a method for communication. The method comprises receiving, at a second network device from a terminal device, an availability indication of a successful handover report of a handover of the terminal device from a first cell of a first network device to a second cell of the second network device, after a handover complete message indicating that the handover is completed is received. The method also comprises transmitting, to the terminal device, a request message for requesting the successful handover report. The method further comprises receiving the successful handover report from the terminal device.

In a fifth aspect, there is provided a method for communication. The method comprises receiving, at a second network device from a terminal device, a handover complete message indicating that a dual active protocol stack (DAPS) handover of the terminal device from a first cell of a first network device to a second cell of the second network device is completed. The method also comprises transmitting, to the terminal device, a reconfiguration message causing the terminal device to release the first cell. The method further comprises receiving, from the terminal device, a reconfiguration complete message containing an availability indication of a successful handover report of the DAPS handover.

In a sixth aspect, there is provided a method for communication. The method comprises receiving, at a second network device from a first network device, a handover request message for a handover of a terminal device from a first cell of the first network device to a second cell of the second network device. The method also comprises generating a handover command message for causing the terminal device to perform the handover and for indicating a report configuration of the second cell. The report configuration indicates whether the second cell supports a successful handover report of the handover.

In a seventh aspect, there is provided a method for communication. The method comprises receiving, at a network device from a terminal device previously performing a handover from a first cell to a second cell, an availability indication of a successful handover report of the handover. The first cell is based on a first radio access technology (RAT) and the second cell is based on a second RAT different from the first RAT. The method also comprises transmitting, to the terminal device, a request message for requesting the successful handover report. The method also comprises receiving the successful handover report from the terminal device. The method further comprises transmitting the successful handover report to a source network device of the handover.

In an eighth aspect, there is provided a method for communication. The method comprises transmitting, at a network device to a terminal device previously performing a handover from a first cell to a second cell, an indication as to whether a third cell provided by the network device supports cross-RAT reporting of a successful handover report of the handover. The first cell is based on a first RAT and the second cell is based on a second RAT different from the first RAT.

In a ninth aspect, there is provided a terminal device. The terminal device comprises a processor configured to perform the method according to the first aspect.

In a tenth aspect, there is provided a first network device. The first network device comprises a processor configured to perform the method according to the second aspect.

In an eleventh aspect, there is provided a second network device. The second network device comprises a processor configured to perform the method according to the third, fourth, fifth, or sixth aspect.

In a twelfth aspect, there is provided a network device. The network device comprises a processor configured to perform the method according to the seventh or eighth aspect.

In a thirteenth aspect, there is provided a computer readable medium having instructions stored thereon. The instructions, when executed on at least one processor of a device, cause the device to perform the method according to the first aspect.

In a fourteenth aspect, there is provided a computer readable medium having instructions stored thereon. The instructions, when executed on at least one processor of a device, cause the device to perform the method according to the second aspect.

In a fifteenth aspect, there is provided a computer readable medium having instructions stored thereon. The instructions, when executed on at least one processor of a device, cause the device to perform the method according to the third, fourth, fifth, or sixth aspect.

In a sixteenth aspect, there is provided a computer readable medium having instructions stored thereon. The instructions, when executed on at least one processor of a device, cause the device to perform the method according to the seventh or eighth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates a schematic diagram of a communication environment in which some embodiments of the present disclosure can be implemented;

FIG. 1B illustrates a schematic diagram of another communication environment in which some embodiments of the present disclosure can be implemented;

FIG. 1C illustrates a schematic diagram of a further communication environment in which some embodiments of the present disclosure can be implemented;

FIG. 2 illustrates an example communication process between a source network device and a terminal device in accordance with some embodiments of the present disclosure;

FIG. 3 illustrates an example communication process among a source network device, a target network device, and a terminal device in accordance with some embodiments of the present disclosure;

FIG. 4 illustrates an example communication process among a source network device, a target network device, and a terminal device in accordance with some embodiments of the present disclosure;

FIG. 5 illustrates an example communication process between a source network device and a terminal device in accordance with some embodiments of the present disclosure;

FIG. 6 illustrates an example communication process between a source network device and a terminal device in accordance with some embodiments of the present disclosure;

FIG. 7 illustrates an example communication process among a source network device, a target network device, and a terminal device in accordance with some embodiments of the present disclosure;

FIG. 8 illustrates an example communication process among a source network device, a target network device, and a terminal device in accordance with some embodiments of the present disclosure;

FIG. 9 illustrates an example communication process between a third network device and a terminal device in accordance with some embodiments of the present disclosure;

FIG. 10 illustrates an example communication process among a source network device, a target network device, and a terminal device in accordance with some embodiments of the present disclosure;

FIG. 11 illustrates an example communication process among a source network device, a third network device, and a terminal device in accordance with some embodiments of the present disclosure;

FIG. 12 illustrates an example communication process between a third network device and a terminal device in accordance with some embodiments of the present disclosure;

FIG. 13 illustrates an example communication process among a target network device, a third network device and a terminal device in accordance with some embodiments of the present disclosure;

FIG. 14 illustrates a flowchart of an example communication method in accordance with some embodiments of the present disclosure;

FIG. 15 illustrates a flowchart of an example communication method in accordance with some embodiments of the present disclosure;

FIG. 16 illustrates a flowchart of an example communication method in accordance with some embodiments of the present disclosure;

FIG. 17 illustrates a flowchart of an example communication method in accordance with some embodiments of the present disclosure;

FIG. 18 illustrates a flowchart of an example communication method in accordance with some embodiments of the present disclosure;

FIG. 19 illustrates a flowchart of an example communication method in accordance with some embodiments of the present disclosure;

FIG. 20 illustrates a flowchart of an example communication method in accordance with some embodiments of the present disclosure;

FIG. 21 illustrates a flowchart of an example communication method in accordance with some embodiments of the present disclosure; and

FIG. 22 illustrates a simplified block diagram of a device that is suitable for implementing some embodiments of the present disclosure.

Throughout the drawings, the same or similar reference numerals represent the same or similar elements.

### DETAILED DESCRIPTION OF EMBODIMENTS

Principles of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can perform communications. Examples of a network device include, but not limited to, a Node B (NodeB or NB), an Evolved NodeB (eNodeB or eNB), a next generation NodeB (gNB), an infrastructure device for a V2X (vehicle-to-everything) communication, a Transmission/Reception Point (TRP), a Remote Radio Unit (RRU), a radio head (RH), a remote radio head (RRH), a low power node, such as a femto node, a pico node, and the like.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, devices on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UEs as examples of terminal devices and the terms “terminal device” and “user equipment” (UE) may be used interchangeably in the context of the present disclosure.

In some embodiments, a terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is an eNB and the second RAT device is a gNB. Information related to different RATs may be transmitted to the terminal device from at least one of the first network device and the second network device. In some embodiments, first information may be transmitted to the terminal device from the first network device and second information may be transmitted to the terminal device from the second network device directly or via the first network device. In some embodiments, information related to configuration for the terminal device configured by the second network device may be transmitted from the second network device via the first network device. Information related to reconfiguration for the terminal device configured by the second network device may be transmitted to the terminal device from the second network device directly or via the first network device.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (memories) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the term “transmission reception point,” “transmission/reception point,” or “transmission and reception point” may generally indicate a station communicating with the user equipment. However, the transmission and reception point may be referred to as different terms such as a base station (BS), a cell, a Node-B, an evolved Node-B (eNB), a next generation NodeB (gNB), a Transmission Reception Point (TRP), a sector, a site, a base transceiver system (BTS), an access point (AP), a relay node (RN), a remote radio head (RRH), a radio unit (RU), an antenna, and the like.

That is, in the context of the present disclosure, the transmission and reception point, the base station (BS), or the cell may be construed as an inclusive concept indicating a portion of an area or a function covered by a base station controller (BSC) in code division multiple access (CDMA), a Node-B in WCDMA, an eNB or a sector (a site) in LTE, a gNB or a TRP in NR, and the like. Accordingly, a concept of the transmission and reception point, the base station (BS), and/or the cell may include a variety of coverage areas such as a mega-cell, a macro-cell, a micro-cell, a pico-cell, a femto-cell, and the like. Furthermore, such concept may include a communication range of the relay node (RN), the remote radio head (RRH), or the radio unit (RU).

In the context of the present disclosure, the user equipment and the transmission/reception point may be two transmission/reception subjects, having an inclusive meaning, which are used to embody the technology and the technical concept disclosed herein, and may not be limited to a specific term or word. Furthermore, the user equipment and the transmission/reception point may be uplink or downlink transmission/reception subjects, having an inclusive meaning, which are used to embody the technology and the technical concept disclosed in connection with the present disclosure, and may not be limited to a specific term or word. As used herein, an uplink (UL) transmission/reception is a scheme in which data is transmitted from user equipment to a base station. Alternatively, a downlink (DL) transmission/reception is a scheme in which data is transmitted from the base station to the user equipment.

As used herein, the term “resource,” “transmission resource,” “resource block,” “physical resource block,” “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, a resource in both frequency domain and time domain will be used as an example of a transmission resource for describing some embodiments of the present disclosure. It is noted that embodiments of the present disclosure are equally applicable to other resources in other domains.

As used herein, the singular forms “a,” “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, in the 3GPP Rel-17 WID Enhancement of data collection for SON/MDT in NR, one of the objectives for SON feature is the successful handover reports. A successful handover report generally refers to a report of a successful handover of a terminal device from a source cell to a target cell. In particular, the successful handover report can be generated by the terminal device performing the successful handover, transmitted by the terminal device to a target network device of the target cell or a subsequent network device later serving the terminal device if the target network device does not obtain the successful handover report, and finally obtained by a source network device of the source cell from the target network device or the subsequent network device.

Based on the successful handover report provided by the terminal device, the source network device and/or the target network device can further optimize future handover procedures to be initiated in the source cell or to be targeted to the target cell, even if the previous handover performed by the reporting terminal device is successful. In this way, the performance of the future handovers can be further improved compared to the previous successful handover. For example, upon reception of the successful handover report, the receiving network device (for example, the source or target network device) is able to analyze whether its mobility configuration needs adjustments. Such adjustments may result in changes of mobility configurations, such as changes of radio link monitoring (RLM) configurations or changes of mobility thresholds between the source network device and the target network device. In addition, the target network device may further optimize the dedicated RACH-beam resources based on the beam measurements reported upon successful handovers.

However, in conventional solutions for supporting the successful handover reports, various details of the successful handover reports have not been specified and need to be clarified. For example, a successful handover report may need to be different from a radio link failure (RLF) report or a handover failure report. Because the RLF report or the handover failure report can be mandatory, for example in Rel-16, which means that a UE needs to always collect RLF information or handover failure information if there is a RLF or a failed handover, and report the collected information to network in any possible chance. In contrast, the successful handover reports may need to be an optional feature, for example, in Rel-17 or other releases of the 3GPP specifications.

More specifically, generating of such a successful handover report for each successful handover may be unnecessary. Instead, it may be desirable that a successful handover report can be optionally or selectively generated for a successful but imperfect handover that needs to be further improved, so as to avoid waste of resources and signaling overhead for unnecessary successful handover reports, and also to reduce the processing complexity on the network side. In summary; in the conventional solutions, the specific mechanism for supporting successful handover reports is not clear and needs to be determined. For example, it is now still unclear as to how to configure the successful handover reports and how to configure the collection of information for generating a successful handover report.

In order to solve the above technical problems and potentially other technical problems in the conventional solutions, embodiments of the present disclosure provide a solution for supporting a successful handover report. In some embodiments, a terminal device receives a report configuration from a first network device providing a first cell. The report configuration indicates whether a successful handover report is to be generated for a handover of the terminal device from the first cell to a second cell of a second network device. Then, the terminal device applies the report configuration during performing of the handover.

With the embodiments of the present disclosure, the source network device can configure the terminal device to optionally compile the successful handover report of the handover, if the source network device determines that the successful handover report needs to be generated by the terminal device. Hence, the successful handover report may be generated only if the report configuration received from the source network device causes the terminal device to do so. This may limit the terminal device to reporting to relevant successful handover cases, such as underlying issues detected by RLM, Beam failure detection (BFD), or the like before or during a successful handover event. In other words, the terminal device may be limited to reporting a successful handover report if the source network device considers the successful handover report as necessary, thereby saving the processing resources and communication resources for the potentially unnecessary successful handover reports. Principles and implementations of the present disclosure will be described in detail below.

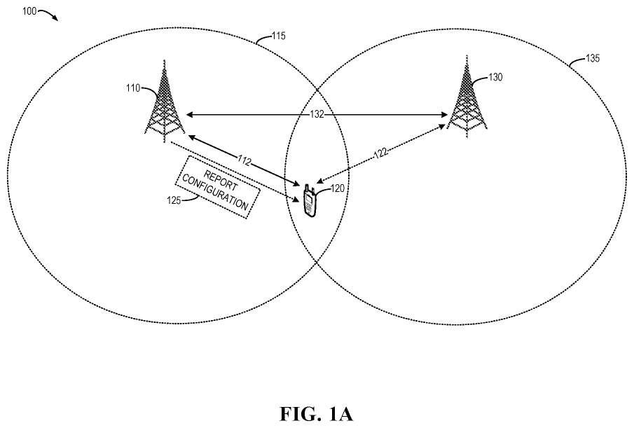

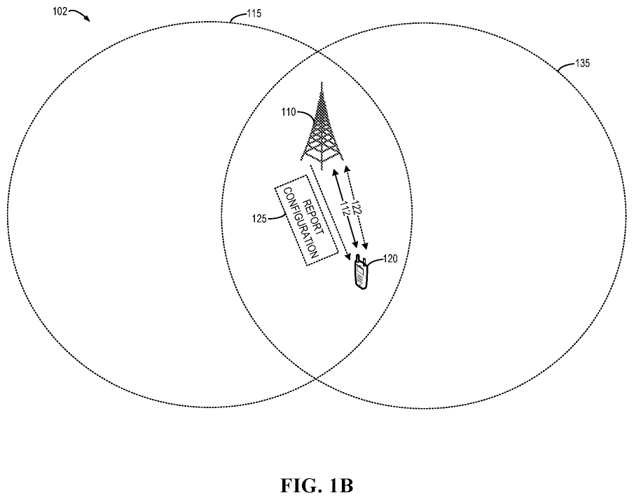

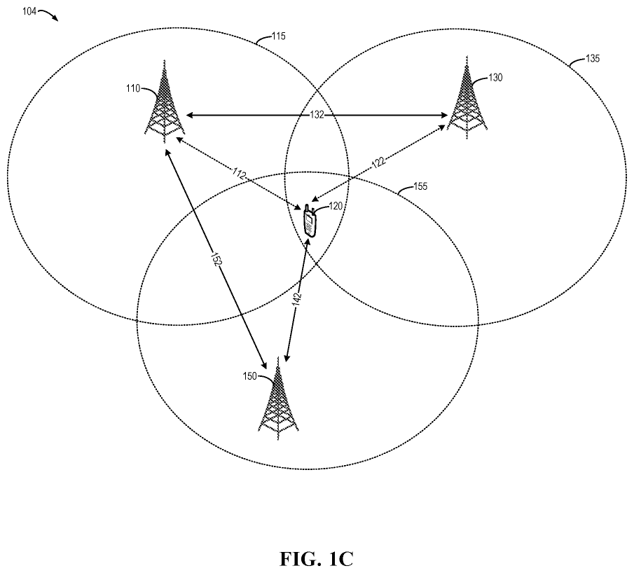

FIG. 1A illustrates a schematic diagram of a communication environment 100 in which some embodiments of the present disclosure can be implemented. As shown in FIG. 1A, the communication environment 100, which may also be referred to as a communication network 100 or a communication system 100, includes a network device 110 serving a terminal device 120 located in a cell 115 provided by the network device 110. In particular, the terminal device 120 may communicate with the network device 110 in the cell 115 via a communication link 112. For transmissions from the network device 110 to the terminal device 120, the communication link 112 may be referred to as a downlink, whereas for transmissions from the terminal device 120 to the network device 110, the communication link 112 may alternatively be referred to as an uplink. As used herein, the network device 110 can also be referred to as a first network device 110 and the cell 115 can also be referred to as a first cell 115.

In the example scenario as shown in FIG. 1A, the terminal device 120 may be leaving the cell 115 of the network device 110 and entering into a cell 135 of a network device 130, due to the mobility of the terminal device 120. In this event, the quality of the link 112 from the terminal device 120 to the cell 115 may be reduced, and thus the communication quality of the terminal device 120 may also be lowered. For providing the terminal device 120 with a better communication quality, the network device 110 can cause the terminal device 120 to perform a handover from the cell 115 to the cell 135. Through the handover, the terminal device 120 may release the link 112 to the cell 115 and instead establish a new link 122 to the cell 135. For the handover from the cell 115 to the cell 135, the cell 115 may also be referred to as a source cell, the network device 110 may also be referred to as a source network device, the cell 135 may also be referred to as a target cell, and the network device 130 may also be referred to as a target network device. In addition, as used herein, the network device 130 can also be referred to as a second network device 130 and the cell 135 can also be referred to as a second cell 135.

More specifically, the handover from the cell 115 to the cell 135 may be performed by the terminal device 120 in a connected mode in which the terminal device 120 is active. The handover can be controlled by the source network device 110 and assisted by the terminal device 120. Before the handover, the terminal device 120 may transmit to the source network device 110 one or more measurement reports that the link 112 to the source cell 115 is getting degraded and/or the target cell 135 is getting better than the source cell 115. Based on these measurement reports, the network device 110 may possibly move (namely, hand over) the connection of the terminal device 120 from the source cell 115 to the target cell 135, so that the terminal device 120 can get better radio conditions and consequently a better user experience.

During the handover of the terminal device 120 from the source cell 115 to the target cell 135, the source network device 110 can communicate necessary information for facilitating the handover with the target network device 130 via a communication link 132, such as an Xn interface between the two network devices. In addition, it is to be appreciated that although the handover of the terminal device 120 from the source cell 115 to the target cell 135 is described above as being due to the movement of the terminal device 120, embodiments of the present disclosure is not limited thereto and may be applicable to handovers caused by various possible reasons.

In some embodiments, the terminal device 120 can generate a successful handover report if the handover from the source cell 115 to the target cell 135 is successful. For example, after the successful handover report is generated, an entry of the successful handover report can be stored in the terminal device 120, such as, in a variable for the successful handover report. In some embodiments, the terminal device 120 can store multiple successful handover report entries corresponding to separate successful handover events. The availability of the successful handover report may be indicated by a message (for example, a handover complete message, such as RRCReconfigurationComplete) transmitted from the terminal device 120 to the target network device 130 over the radio resource control (RRC) layer. The target network device 130 may fetch the information in the successful handover report via a UE Information Request and Response mechanism.

In some embodiments, after providing the successful handover report to the network via a message (such as, UEAssistanceResponse), the terminal device 120 can discard the stored successful handover report in the variable. The target network device 130 may then forward the successful handover report to the source network device 110, for example, via the link 132 between the two network devices, to indicate failures experienced during a successful handover event. In some embodiments, the terminal device 120 can discard the stored entry of the successful handover report after predetermined duration (for example, 48 hours) since it is stored, if the stored entry keeps being not fetched by the network.

Based on the successful handover report provided by the terminal device 120, the source network device 110 and/or the target network device 130 can further improve future handover procedures to be initiated in the source cell 115 or to be targeted to the target cell 135, even if the previous handover performed by the reporting terminal device 120 is successful. For example, upon reception of the successful handover report, the source network device 110 and/or the target network device 130 may be able to analyze whether its mobility configuration needs to be adjusted. Such adjustments may result in changes of RLM configurations, changes of mobility thresholds between the source network device 110 and the target network device 130, and so on.

In some embodiments, since a main purpose of the successful handover reports is to help the source and target network devices in further optimizing future handovers related to the source and target network devices based on an already successful handover, it may be unnecessary for a terminal device to generate a successful handover report for each successful handover. Instead, it may be desirable for a terminal device to selectively or optionally generate a successful handover report for a successful but imperfect handover that may need to be further improved. To this end, as shown in FIG. 1A, before or when the source network device 110 causes the terminal device 120 to perform the handover from the cell 115 to the cell 135, the source network device 110 may transmit a report configuration 125 to the terminal device 120. The report configuration 125 can indicate whether a successful handover report is to be generated for the handover from the cell 115 to the cell 135.

After obtaining the report configuration 125, the terminal device 120 can apply the report configuration 125 during performing of the handover from the cell 115 to the cell 135. For example, if the report configuration 125 indicates that the successful handover report is to be generated for the handover, then the terminal device 120 can compile the successful handover report for the following handover. Otherwise, if the report configuration 125 indicates that the successful handover report is not to be generated for the handover, then the terminal device 120 can perform the following handover without compiling the successful handover report. In this way; the successful handover report can be selectively or optionally generated by the terminal device 120 based on the report configuration 125 determined by the source network device 110. Accordingly, the terminal device 120 may be limited to reporting a successful handover report when it is considered by the source network device 110 as necessary, thereby saving the processing resources and communication resources of the terminal device 120 for unnecessary successful handover reports, and also reducing the processing complexity on the network side.

It is noted that the handover of the terminal device 120 from the cell 115 to the cell 135 as discussed above with reference to FIG. 1A may be referred to as an inter-network-device handover, in which the source cell 115 and the target cell 135 are provided by different network devices 110 and 130. However, it should be understood that in addition to such an inter-network-device handover, embodiments of the present disclosure are also applicable to an intra-network-device handover, in which the source cell 115 and the target cell 135 may be provided by a same network device. An example of such an intra-network-device handover will be described below with reference to FIG. 1B.

FIG. 1B illustrates a schematic diagram of another communication environment 102 in which some embodiments of the present disclosure can be implemented. Similar to the example scenario of FIG. 1A, the network device 110 in the example scenario as shown in FIG. 1B also provides the cell 115 and the terminal device 120 may have the communication link 112 to the cell 115. Also similar to the example scenario of FIG. 1A, the terminal device 120 in the example scenario as shown in FIG. 1B can also perform a handover from the cell 115 to the cell 135, for example, due to the movement of the terminal device towards the cell 135. Through the handover, the terminal device 120 may release the link 112 to the source cell 115 and instead establish the link 122 to the target cell 135. Different from the example scenario of FIG. 1A, the target cell 135 in the example scenario as shown in FIG. 1B can also be provided by the same network device 110 providing the source cell 115, and thus the handover in FIG. 1B can be referred to as an intra-network-device handover.

The procedure of the intra-network-device handover performed by the terminal device 120 in FIG. 1B may be largely analogous to the inter-network-device handover as described above with reference to FIG. 1A, except that the communications between two network devices for facilitating the handover may not be needed. Similar to the example scenario of FIG. 1A, before or when the network device 110 causes the terminal device 120 to perform the intra-network-device handover from the cell 115 to the cell 135, the network device 110 may transmit the report configuration 125 to the terminal device 120.

After obtaining the report configuration 125, the terminal device 120 can apply the report configuration 125 during performing of the intra-network-device handover. In this way, the successful handover report can be selectively or optionally generated by the terminal device 120 based on the report configuration 125 determined by the network device 110. Accordingly, the terminal device 120 may be limited to reporting a successful handover report when it is considered by the network device 110 as necessary, thereby saving the processing resources and communication resources of the terminal device 120 for unnecessary successful handover reports, and also reducing the processing complexity on the network side.

As described above with reference to FIG. 1A, if the successful handover report is generated by the terminal device 120 for the handover from the cell 115 to the cell 135, the availability of the successful handover report may be indicated by the terminal device 120 to the target network device 130 via a message, for example, a handover complete message. The target network device 130 may obtain the successful handover report via a UE Information Request and Response mechanism. In some embodiments, after providing the successful handover report to the network via a message (such as, UEAssistanceResponse), the terminal device 120 can discard the stored successful handover report in the variable.

However, in some embodiments, after receiving the availability of the successful handover report from the terminal device 120, the target network device 130 may not obtain the successful handover report from the terminal device 120 due to some reasons, before the terminal device 120 release the link 122 to the cell 135. For example, the terminal device 120 may keep moving and leaving the cell 135 before the target network device 130 fetches the successful handover report from the terminal device 120. In these embodiments, since the successful handover report is still stored in the terminal device 120 and thus available for the network, the terminal device 120 can indicate the availability of the successful handover report to a third network device providing a subsequent serving cell of the terminal device 120. An example of such a situation will be described below with reference to FIG. 1C.

FIG. 1C illustrates a schematic diagram of a further communication environment 104 in which some embodiments of the present disclosure can be implemented. As shown in FIG. 1C, it is assumed that the terminal device 120 previously performed the handover from the cell 115 to the cell 135 and generated the successful handover report of the handover. It is also assumed that the target network device 130 did not fetch the successful handover report from the terminal device 120 and now the terminal device 120 is connecting to a cell 155 provided by a network device 150. As used herein, the network device 150 can also be referred to as a third network device 150 and the cell 155 can also be referred to as a third cell 155.

In this event, similar to the procedure discussed above with reference to the example scenario of FIG. 1A, the availability of the successful handover report of the handover from the cell 115 to the cell 135 may be indicated by a message (for example, a handover complete message, such as RRCReconfigurationComplete) transmitted from the terminal device 120 to the network device 150 over the RRC layer. The network device 150 may fetch the information in the successful handover report via a UE Information Request and Response mechanism. In some embodiments, after providing the successful handover report to the network device 150 via a message (such as, UEAssistanceResponse), the terminal device 120 can discard the stored successful handover report in the variable. The network device 150 may then forward the successful handover report to the source network device 110 of the handover, for example, via a link 152 between the two network devices, to indicate failures experienced during the successful handover from the cell 115 to the cell 135.

It is to be noted that the network device 150 is not necessarily a serving network device of the terminal device 120 immediately after the network device 130 serves the terminal device 120. In other words, there may be one or more other serving network devices of the terminal device 120 after the terminal device 120 releases the link 122 to the cell 135 and before the terminal device 120 establishes the link 142 to the cell 155. Similar to the network device 130, the one or more other serving network devices also do not fetch the successful handover report from the terminal device 120. In the following description, some embodiments will be further detailed in connection with the example scenario as shown in FIG. 1A. However, it should be understood that all the embodiments can also be applied to the intra-network-device handover as shown in FIG. 1B and the scenario in which the successful handover report is fetched by a network device other than the target network device as shown FIG. 1C.

It is to be understood that the number of the terminal devices, the number of the network devices, the number of cells, and the number of communication links as shown in FIGS. 1A, 1B and 1C are only for the purpose of illustration without suggesting any limitations. The communication environment 100, 102 and 104 may include any suitable number of terminal devices, any suitable number of network devices, any suitable number of other communication devices, any suitable number of cells, and any suitable number of communication links adapted for implementing embodiments of the present disclosure.

In addition, it is to be appreciated that there may be various wireless communications as well as wireline communications (if needed) among all the communication devices in FIGS. 1A, 1B and 1C. Moreover, it is noted that although the network device 110, the network device 130, and the network device 150 are schematically depicted as base stations and the terminal device 120 is schematically depicted as a mobile phone in FIGS. 1A, 1B and 1C, it is understood that these depictions are only for example without suggesting any limitation. In other embodiments, the network device 110, the network device 130, and the network device 150 may be any other wireless network devices, and the terminal device 120 may be any other wireless communication device.

The communications in the communication environment 100, 102 and 104 may conform to any suitable standards including, but not limited to, Global System for Mobile Communications (GSM), Extended Coverage Global System for Mobile Internet of Things (EC-GSM-IoT), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

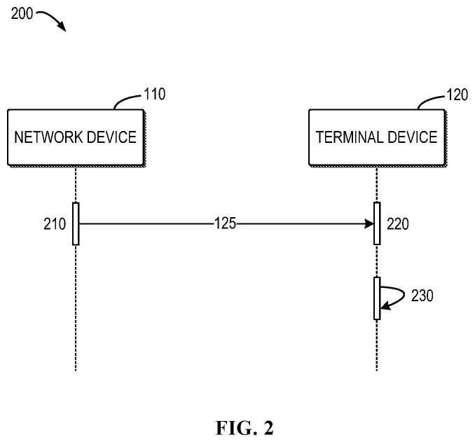

FIG. 2 illustrates an example communication process 200 between the source network device 110 and the terminal device 120 in accordance with some embodiments of the present disclosure. For the purpose of discussion, the communication process 200 will be described with reference to FIGS. 1A, 1B and 1C. However, it would be appreciated that the communication process 200 may be equally applicable to any other communication scenarios where two communication devices communicate with each other.

As shown in FIG. 2, in order to inform the terminal device 120 of the configuration of the successful handover report for the handover of the terminal device 120 from the cell 115 to the cell 135, the network device 110 transmits (210) the report configuration 125 to the terminal device 120. As discussed above, the report configuration 125 may indicate whether the successful handover report is to be generated for the handover of the terminal device 120 from the cell 115 to the cell 135. In other words, the report configuration 125 can be determined and informed to the terminal device 120 by the source network device 110. This is because the successful handover report may be reported to and utilized by the source network device 110 to further enhance handover performance, for example, by optimizing the time point for triggering a future handover and the selecting of a target cell for the future handover. Therefore, it may be reasonable that the source network device 110 configures whether the terminal device 120 generates the successful handover report for the handover initiated in source cell 115.

In general, the report configuration 125 can employ any suitable manner to indicate whether the successful handover report is to be generated for the handover. In some embodiments, the report configuration 125 may simply include an explicit indication that the successful handover report is to be generated. In this way, the signaling overhead of the report configuration 125 and the complexity for configuring the report configuration 125 may be minimized. More specifically, the explicit indication may mean that successful handover reports are to be generated for all the handovers initiated in the cell 115. Alternatively, the explicit indication may mean that a successful handover report is to be generated for the particular handover of the terminal device 120. As another alternative, the explicit indication may mean that the successful handover report is supported for a handover initiated in the cell 115, but is to be triggered when a triggering condition is fulfilled before or during the handover. For example, the terminal device 120 may be configured with a set of triggering conditions by default, and the explicit indication can represent that all the set of triggering conditions are enabled for a handover initiated in the cell 115. In some embodiments, the explicit indication can be a bit having a predetermined value, such as, 1.

In some other embodiments, the report configuration 125 may include a triggering condition for triggering the successful handover report to be generated for the handover from the cell 115 to the cell 135. For example, before or when performing the handover, the terminal device 120 can determine whether the triggering condition is satisfied or not. If the triggering condition is satisfied, then the terminal device 120 may generate the successful handover report for the handover. Otherwise, if the triggering condition is not satisfied, then the terminal device 120 may not generate the successful handover report for the handover. In other words, if the cell 115 is configured with successful handover reports, the terminal device 120 can collect information to be reported in the successful handover report and related to the handover event triggered in the cell 115 (namely, as a source cell of the handover), if the triggering condition is fulfilled. By configuring one or more triggering conditions for triggering a successful handover report, the network device 110 can precisely configure the terminal device 120 to compile a successful handover report for a successful but imperfect handover.

It is to be noted that in some embodiments, the report configuration 125 may include both the indication that the successful handover report is to be generated, and one or more specific triggering conditions for triggering the successful handover report of a handover initiated in the cell 115. For example, even if the terminal device 120 is configured with a set of triggering conditions by default, the terminal device 120 may generate a successful handover report for a handover initiated in the cell 115, based on the one or more specific triggering conditions contained in the report configuration 125, rather than the default set of triggering conditions. For example, the one or more specific triggering conditions contained in the report configuration 125 may be a subset of the default set of triggering conditions or may include different triggering conditions other than the set of triggering conditions.

Generally, the triggering condition for triggering a successful handover report can be any suitable triggering condition implying a successful but imperfect handover that may need to be further improved. For example, the triggering condition may be a radio problem towards the source cell being detected prior to handover triggering, a RACH delay during handover procedure being detected, a quality change threshold being reached, an absolute quality threshold for the main measurement moments being reached, the handover being initiated during running of the timer T310/T312 as defined in the related 3GPP specifications, RRCReconfiguration being executed, and so on.

The network device 110 may transmit the report configuration 125 to the terminal device 120 via any existing, dedicated or future designed message or signaling. For example, as a first option, the network device 110 can broadcast system information of the cell 115 for indicating the report configuration 125. In other words, the report configuration 125 may be carried in the system information of the cell 115. In this case, all the terminal devices in the cell 115 may apply the report configuration 125. As such, the network device 110 may determine a common configuration for all the terminal devices in the cell 115 and all the handovers initiated in the cell 115, thereby simplifying the operations for determining and informing of the report configuration 125. Also, the terminal devices in the cell 115 can obtain the report configuration 125 at any time in either the idle or the active state, thereby enhancing the availability of the report configuration 125 for the terminal devices. In some embodiments, the system information may be an existing SIB (for example, the SIB1) or a new SIB.

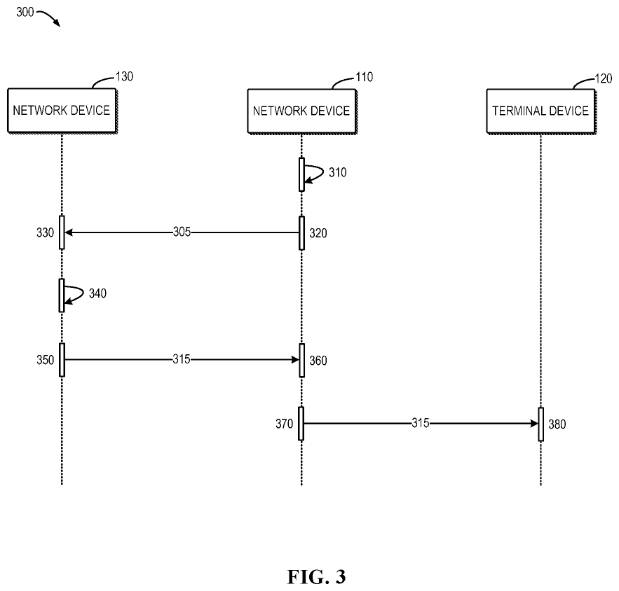

As a second option, the network device 110 may transmit a message (such as an RRC message or signaling) for causing the terminal device 120 to perform the handover and for indicating the report configuration 125. As used herein, such a message may also be referred to as a first message for ease of discussion. In other words, the report configuration 125 can be carried in the first message for causing the terminal device 120 to perform the handover, such as, a handover command message or handover command signaling. In this way, the report configuration 125 can be a dedicated configuration, namely; specific to a particular terminal device or a particular handover, but not for all the terminal devices and all the handovers in the cell 115. Thus, compared to the above discussed first option, the second option can provide more flexibility of the report configuration 125, thereby improving the effectiveness of the successful handover report and also reducing the processing complexity of the network. In some embodiments, the generating of the first message may involve interactions between the source network device 110 and the target network device 130. For example, the source network device 110 may need to send the report configuration 125 to the target network device 130, which in turn generating the first message to include the report configuration 125. Such interactions will be later described with reference to FIG. 3.

As a third option, the network device 110 may transmit a message (such as an RRC message or signaling) specific to the terminal device 120 for indicating the report configuration 125, prior to a handover command message causing the terminal device 120 to perform the handover is transmitted to the terminal device 120. As used herein, such a message transmitted before the handover command message may also be referred to as a second message for ease of discussion. In other words, the report configuration 125 may be carried in the second message transmitted before the handover command message. In some embodiments, the second message may be the RRCReconfiguration message transmitted to the terminal device 120 before the handover. Upon receiving the second message, the terminal device 120 may store the report configuration 125 in a UE variable for further use when the handover is initiated. The UE variable for storing the report configuration 125 may be different from the UE variable for storing information to be included in the successful handover report.

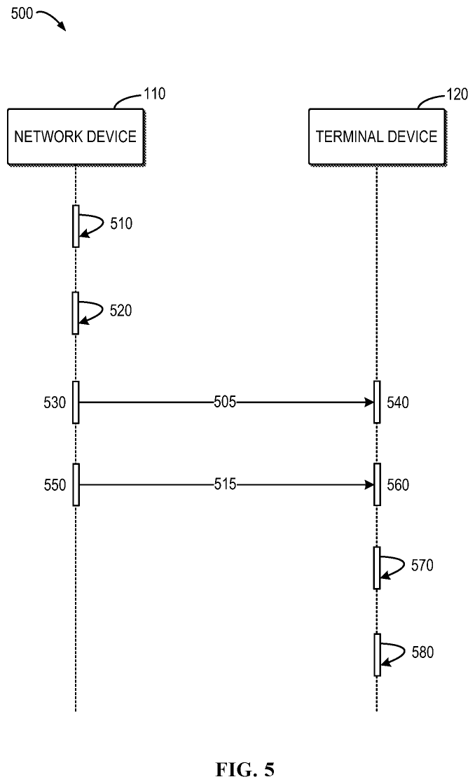

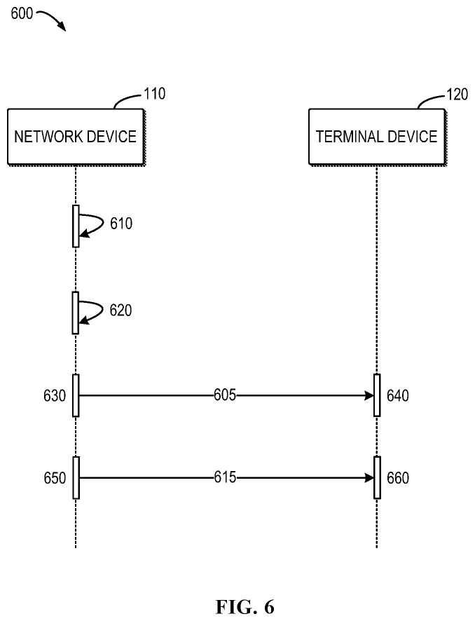

By being carried in the second message transmitted before the handover command message, the report configuration 125 can be a dedicated configuration, namely, specific to a particular terminal device, but not for all the terminal devices and all the handovers in the cell 115. Thus, compared to the above discussed first option, the third option can provide more flexibility of the report configuration 125, thereby improving the effectiveness of the successful handover report and also reducing the processing complexity of the network. In addition, compared with the above discussed second option, since the source network device 110 does not need to send the report configuration 125 to the target network device 130, the third option may not have impact on inter-network-device signaling. In addition, it is noted that the second message is not necessarily a message immediately before the handover command message, but there can be other intervening messages between the second message and the handover command message. In some embodiments, the above discussed first option and the second option (or the third option) can be supported simultaneously. Such embodiments will be further described later with reference to FIGS. 5 and 6.

On the other side of the communication process 200, the terminal device 120 receives (220) the report configuration 125 from the network device 110. For example, if the report configuration 125 is broadcast via the system information of the cell 115, the terminal device 120 may receive the system information and obtain the report configuration 125 from the system information. If the report configuration 125 is contained in the first message for causing the terminal device 120 to perform the handover, upon receiving the first message from the network device 110, the terminal device 120 can initiate the handover and obtain the report configuration 125 from the first message. If the report configuration 125 is transmitted via a second message transmitted before the handover command message, the terminal device 120 can obtain the report configuration 125 from the second message and store the report configuration 125 for future use when the handover is initiated.

Then, the terminal device 120 applies (230) the report configuration 125 during the performing of the handover from the cell 115 to the cell 135. For example, if the report configuration 125 indicates that the successful handover report is to be generated for the handover, then the terminal device 120 can collect information to be reported in the successful handover report before or during the performing of the handover. As such, the information to be reported in the successful handover report can be collected only if the successful handover report is determined by the network device 110 as necessary, thereby avoiding unnecessary collecting of the information for all the successful handovers. In general, the information collected by the terminal device 120 and to be contained in the successful handover report can include any information that can be helpful for the source network device 110 or the target network device 130 to improve the performance of future handovers. For example, the collected information may include RLM related information, BFD related information, and handover related information, or the like.

On the other hand, if the report configuration 125 indicates that the successful handover report is not to be generated for the handover, then the terminal device 120 may avoid collecting information for the successful handover report before or during the performing of the handover. That is, the terminal device 120 may perform the handover from the cell 115 to the cell 135 without collecting the information for generating the successful handover report. As such, the terminal device 120 may not collect the information to be reported in the successful handover report if the successful handover report is determined by the network device 110 as unnecessary, thereby saving unnecessary overhead to collect the information for all the successful handovers. Through the communication process 200, it can be under the control of the network whether the terminal device 120 is to collect the information to be included in the successful handover report and generate the successful handover report. Accordingly, the network device 110 can configure the terminal device 120 to compile the successful handover report when necessary.

In some embodiments, delta configuration may be not applied to the report configuration 125. In other words, upon a successful handover to the target cell 135 or an RRC reestablishment to another cell, the terminal device 120 may release the report configuration 125. The reason may be that if the delta configuration is supported for the report configuration 125, the other cell (for example, the target cell 135 or a re-established cell) may need to send a message (or signaling) to cause the terminal device to release the report configuration 125 of the source cell 115, in case the other cell does not support successful handover reports. This can introduce additional complexity and signaling overhead. Otherwise, if the message (or signaling) to release the report configuration 125 is not sent, the terminal device 120 may store and report unnecessary successful handover reports.

More specifically, after the handover from the cell 115 to the cell 135 is completed, the terminal device 120 may release the report configuration 215. For example, the terminal device 120 can remove the report configuration 215 from the UE variable for storing the report configuration 215. Similarly, if the handover from the cell 115 to the cell 135 is failed, the terminal device 120 may reestablish a connection to an available cell, and then release the report configuration 215. For example, the terminal device 120 can delete the report configuration 215 in the UE variable. Because the terminal device 120 may release the report configuration 215 after connecting to a new cell other than the cell 115, the potential additional complexity and signaling overhead due to the delta configuration can be avoided.

In some embodiments, the report configuration 215 indicates that the successful handover report is to be generated for the handover from the cell 115 to the cell 135, and thus the terminal device 120 collects information to be reported in the successful handover report before or during the performing of the handover. It is noted that the collected information to be reported in the successful handover report is usually stored by the terminal device 120 when the handover is not completed, but the handover from the cell 115 to the cell 135 may be finally failed. In such circumstances, since the handover is not a successful handover, the terminal device 120 may discard the previously collected information to be reported in the successful handover report. For example, if the timer T304 as defined in related 3GPP specifications expires (which may indicate a handover failure), the terminal device 120 can discard the stored entry of the successful handover report corresponding to the failed handover event. In this way, the terminal device 120 can have one additional discard condition for a successful handover report compared to the conventional solutions, and can avoid reporting wrong information to the network.

FIG. 3 illustrates an example communication process 300 among the source network device 110, the target network device 130, and the terminal device 120 in accordance with some embodiments of the present disclosure. As indicated above, FIG. 3 mainly shows the interactions between the source network device 110 and the target network device 130 for generating the first message as discussed hereinbefore, namely, the message for causing the terminal device 120 to perform the handover from the cell 115 to the cell 135 and for indicating the report configuration 125. For the purpose of discussion, the communication process 300 will be described with reference to FIG. 1A. However, it would be appreciated that the communication process 300 may be similarly applicable to the communication scenarios in FIGS. 1B and 1C as well as any other communication scenarios.

As shown in FIG. 3, after determining (310) that the handover of the terminal device 120 from the cell 11 to the cell 135 is to be performed, the network device 110 may transmit (320) a handover request message 305 to the second network device 130. The handover request message 305 may be used for requesting the target network device 130 to prepare for the handover of the terminal device 120 to the target cell 135. In addition, the handover request message 305 may contain the report configuration 215. In some embodiments, the handover request message 305 may be inter-node Handover Preparation signaling, such as, inter-node RRC message HandoverPreparationInformation or inter-node Xn message HandoverRequest.

Accordingly, upon receiving (330) the handover request message 305 from the network device 110, the network device 130 may generate (340) a message 315, which may be an example of the first message discussed above. For example, the network device 130 may incorporate the report configuration 215 into the message 315. In some embodiments, the message 315 may be an inter-node RRC message, such as a handover command message or an RRCReconfiguration with reconfigurationWithSync. Thus, the message 315 can be used for causing the terminal device 120 to perform the handover and also for indicating the report configuration 215.

Then, the network device 130 may transmit (350) the message 315 to the network device 110. After receiving (360) the message 315 from the network device 130, the network device 110 may in turn transmit (370) the message 315 to the terminal device 120. Upon receiving (380) the message 315 from the network device 110, the terminal device 120 may perform the handover from the cell 115 to the cell 135 and can obtain the report configuration 215 from the message 315. Through the communication process 300, the report configuration 215 can be included in the first message, for example, a handover command message, by taking advantage of the interaction process between the source network device 110 and the target network device 130 for facilitating the handover.

In the communication process 300 in FIG. 3, the report configuration 215 is incorporated by the target network device 130 into the first message. In some other embodiments, the handover of the terminal device 120 from the cell 115 to the cell 135 may be a conditional handover. In these embodiments, the report configuration 215 may be alternatively incorporated by the source network device 110 into the first message. The conditional handover is one of the main mobility enhancements specified by 3GPP in Rel-16, which focuses on reducing the number of failure occurrences while a terminal device is moving, for example, when a handover between cells fails, or when a connection fails even before a handover is triggered.

For example, with reference to FIG. 1A, it is assumed that the handover of the terminal device 120 from the cell 115 to the cell 135 is a conditional handover. In such a case, instead of preparing one target cell as in the normal case, multiple candidate target cells including the cell 135 can be prepared in advance in the network device 110. The network device 110 may enable a handover command to be sent to the terminal device 120 earlier than at normal handover when the radio conditions are still good, rather than when conditions start to get degraded as in normal handover. When received the handover command, the terminal device 120 may store the handover command, instead of applying the handover command immediately. In fact, the terminal device 120 may only apply the stored handover command when a condition configured in the terminal device 120 is satisfied for one (for example, the cell 135 in the example scenario of FIG. 1A) of the configured candidate target cells, and then the terminal device 120 can execute the handover and connects to the target network device 130 as in a normal handover.

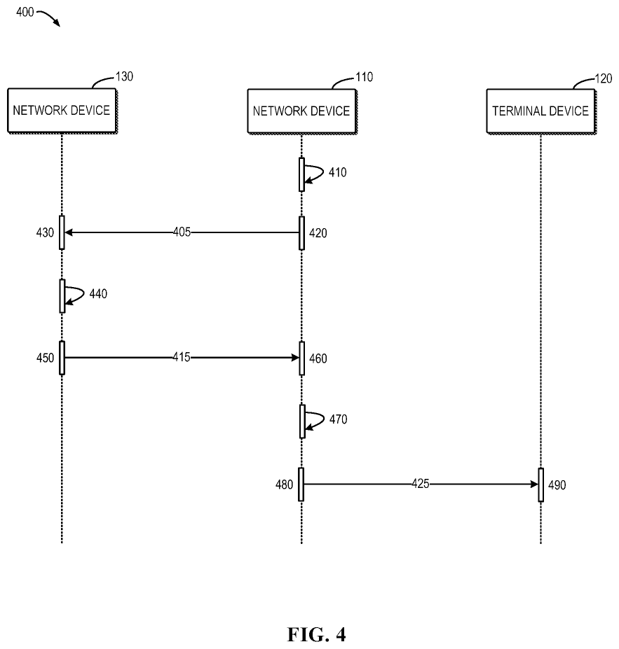

FIG. 4 illustrates an example communication process 400 among the source network device 110, the target network device 130, and the terminal device 120 in accordance with some embodiments of the present disclosure. For the purpose of discussion, the communication process 400 will be described with reference to FIG. 1A. However, it would be appreciated that the communication process 400 may be similarly applicable to the communication scenarios in FIGS. 1B and 1C as well as any other communication scenarios. In the communication process 400, it is assumed that the handover of the terminal device 120 from the cell 115 to the cell 135 is a conditional handover.

As shown in FIG. 4, upon determining (410) that the conditional handover is to be performed, the network device 110 may transmit (420) a handover request message 405 to the network device 130. Upon receiving (430) the handover request message 405 from the network device 110, the network device 130 may generate (440) a handover command message 415 for causing the terminal device 120 to perform the conditional handover. The network device 130 may transmit (450) the handover command message 415 to the network device 110.

Upon receiving (460) the handover command message 415 from the network device 130, the network device 110 can generate (470) a message 425 (for example, an RRC message) by incorporating the report configuration 215 and the handover command message 415 into the message 425. The message 425 may be an example of the first message discussed above. In some embodiments, the message 425 may be an RRCReconfiguration with ConditionalReconfiguration. The network device 110 may transmit (480) the message 425 to the terminal device 120, and thus the terminal device 120 can receiver (490) the message 425 from the network device 110.

Through the communication process 400, the report configuration 215 can be included by the source network device 110 in the first message for causing the terminal device 120 to perform the conditional handover, by taking advantage of the interaction process between the source network device 110 and the target network device 130 for facilitating the conditional handover. However, it is to be noted that the example communication process 300 as shown in FIG. 3 is also applicable to a conditional handover from the cell 115 to the cell 135.

FIG. 5 illustrates an example communication process 500 between the source network device 110 and the terminal device 120 in accordance with some embodiments of the present disclosure. As indicated above, FIG. 5 mainly shows a scenario in which the network device 110 simultaneously supports the above mentioned first option and the second option (or the third option) for transmitting the report configuration 215. For the purpose of discussion, the communication process 500 will be described with reference to FIG. 1A. However, it would be appreciated that the communication process 500 may be similarly applicable to the communication scenarios in FIGS. 1B and 1C as well as any other communication scenarios.

As shown in FIG. 5, the network device 110 may determine (510) a first candidate report configuration with a first priority, and determine (520) a second candidate report configuration with a second priority higher than the first priority. As such, since the network device 110 can configure two candidate report configurations with different priorities, the flexibility in configuring the report configuration 215 may be increased. With reference to both FIGS. 2 and 5, in transmitting (210) the report configuration 215 to the terminal device 120, the network device 110 can broadcast (530) system information 505 of the cell 115 for indicating the first candidate report configuration. In this way, the candidate report configuration with the lower priority may be transmitted via the system information 505, so that the terminal device 120 can have a basic report configuration for the successful handover report.

In addition, in transmitting (210) the report configuration 215 to the terminal device 120, the network device 110 can also transmit (550) a message 515 to the terminal device 120. In some embodiments, the message 515 may be an example of the first message for causing the terminal device 120 to perform the handover and for indicating the second candidate report configuration. In some other embodiments, the message 515 may be an example of the second message specific to the terminal device 120 for indicating the second candidate report configuration prior to a handover command message for causing the terminal device 120 to perform the handover is transmitted to the terminal device 120. As such, the candidate report configuration with the higher priority may be transmitted via the message 515 specific to the terminal device 120, so that the terminal device 120 can have a dedicated report configuration for the successful handover report if the network device 110 considers the dedicated report configuration as necessary.

With reference to both FIGS. 2 and 5, in receiving (220) the report configuration 215 from the network device 110, the terminal device 120 may receive (540) the first candidate report configuration via the system information 505, and also receive (560) the second candidate report configuration via the message 515. Upon receiving the first candidate report configuration and the second candidate report configuration, the terminal device 120 can determine (570) that the second priority is higher than the first priority. Then, the terminal device 120 may determine (580) the second candidate report configuration as the report configuration 215. In other words, the terminal device 120 may apply the second option (or the third option) instead of the first option, if they are both configured. That is, the dedicated candidate report configuration may take a higher priority. Through the communication process 500, since the network device 110 can configure the terminal device 120 with two candidate report configurations having different priorities, the flexibility in the configuration and the function of the report configuration 215 may be further improved.

FIG. 6 illustrates an example communication process 600 between the source network device 110 and the terminal device 120 in accordance with some embodiments of the present disclosure. As indicated above, FIG. 6 mainly shows a scenario in which the network device 110 simultaneously supports the above mentioned first option and the second option (or the third option) for transmitting the report configuration 215. For the purpose of discussion, the communication process 600 will be described with reference to FIG. 1A. However, it would be appreciated that the communication process 600 may be similarly applicable to the communication scenarios in FIGS. 1B and 1C as well as any other communication scenarios.

As shown in FIG. 6, the network device 110 may determine (610) a first part of the report configuration 215, and determine (620) a second part of the report configuration 215. As such, since the network device 110 can configure two different parts of the report configuration 215, flexibility in configuring the report configuration 215 may be increased. For example, the first part of the report configuration 215 may be the report configuration part for a normal handover, whereas the second part of the report configuration 215 may be the report configuration part for a special handover, such as, a conditional handover, a DAPS handover, and so on. With reference to both FIGS. 2 and 6, in transmitting (210) the report configuration 215 to the terminal device 120, the network device 110 can broadcast (630) system information 605 of the cell 115 for indicating the first part of the report configuration 215. In this way, since the first part of the report configuration 215 may be transmitted via the system information 505, so that the terminal device 120 can have a basic part of the report configuration 215.

In addition, in transmitting (210) the report configuration 215 to the terminal device 120, the network device 110 can also transmit (650) a message 615 to the terminal device 120. In some embodiments, the message 615 can be an example of the first message for causing the terminal device 120 to perform the handover and for indicating the second part of the report configuration 215. In some other embodiments, the message 615 can be an example of the second message specific to the terminal device 120 for indicating the second part of the report configuration 215, prior to a handover command message for causing the terminal device 120 to perform the handover is transmitted to the terminal device 120. As such, since the second part of the report configuration 215 may be transmitted via the message 615 specific to the terminal device 120, so that the terminal device 120 can have a dedicated part of the report configuration 215 if the network device 110 considers the dedicated part as necessary.

With reference to both FIGS. 2 and 6, in receiving (220) the report configuration 215 from the network device 110, the terminal device 120 may receive (640) the first part of the report configuration 215 via the system information 605, and also receive (650) the second part of the report configuration 215 via the message 615. It can be seen that the second or third option can configure additional parameters of the successful handover reports that are not included in the first option. Through the communication process 600, since the network device 110 can transmit different parts of the report configuration 215 using different signaling messages, the flexibility in the configuration and the transmission of the report configuration 215 may be further increased.

Hereinbefore, some embodiments are described as to how to configure the successful handover reports. Hereinafter, some other embodiments will be described with regard to the reporting of the successful handover reports. For example, if the successful handover report is generated by the terminal device 120, then how the terminal device 120 can report the successful handover report to the network. In these embodiments, the reporting scheme of the successful handover reports can be extended compared to the conventional solutions.

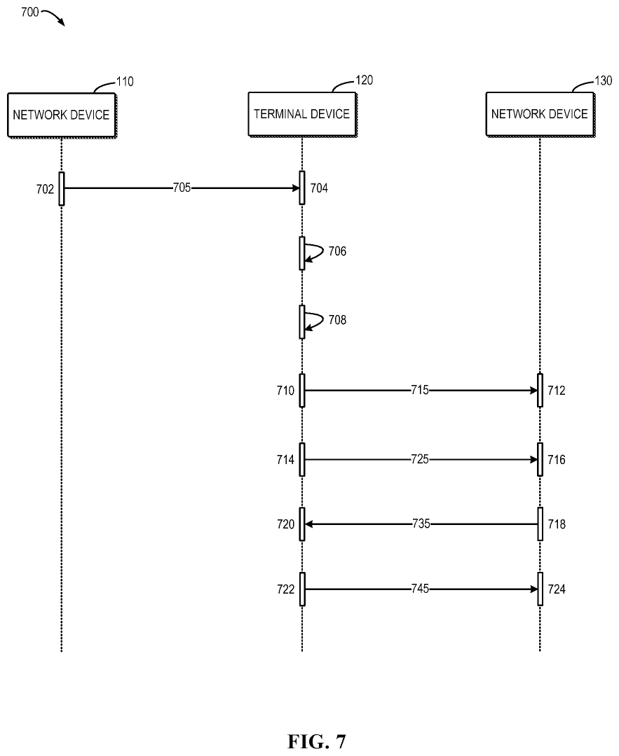

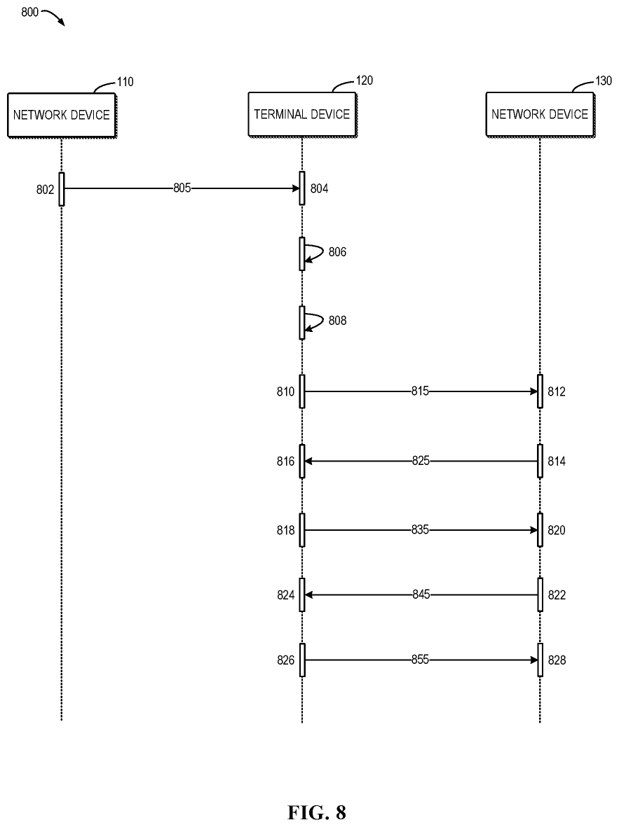

In the conventional solutions, if the successful handover report is generated by the terminal device 120, the availability of the successful handover report can be indicated to the network in a handover completion message (for example, an RRCReconfigurationComplete). However, in some cases, the information to be reported in the successful handover report may be stored after the handover completion message is generated. This means that it may be impossible to indicate the availability of the successful handover report in the already generated handover completion message. Therefore, in some embodiments, the availability of the successful handover report can be transmitted to the network via a message after the handover completion message, and thus addressing the issues of the conventional schemes occurred if the successful handover report is generated after the handover completion message. Such embodiments will be further described with reference to FIGS. 7 and 8.

FIG. 7 illustrates an example communication process 700 among the source network device 110, the target network device 130 and the terminal device 120 in accordance with some embodiments of the present disclosure. For the purpose of discussion, the communication process 700 will be described with reference to FIG. 1A. However, it would be appreciated that the communication process 700 may be similarly applicable to the communication scenarios in FIGS. 1B and 1C as well as any other communication scenarios. In the communication process 700, it is assumed that the report configuration 215 indicates that the successful handover report is to be generated for the handover of the terminal device 120 from the cell 115 to the cell 135. Thus, the terminal device 120 may collect information to be reported in the successful handover report during the performing of the handover.

As shown in FIG. 7, the network device 110 may transmit (702) a message 705 to the terminal device 120. The message 705 can cause the terminal device 120 to perform the handover from the cell 115 to the cell 135. For example, the message 705 may be an RRC message for performing a handover. Upon receiving (704) the message 705 from the network device 110, the terminal device 120 can perform the handover from the cell 115 to the cell 135. If the handover is completed, the terminal device 120 may generate (706) a message 715 indicating that the handover is completed. Thus, the message 715 can also be referred to as a handover complete message 715. After generating (706) the message 715, the terminal device 120 may generate (708) the successful handover report 745 of the handover by storing the collected information in the successful handover report 745. For example, the terminal device 120 may detect that a triggering condition for the successful handover report 745 is satisfied after the generating (706) the message 715.

Then, the terminal device 120 can transmit (710) the handover complete message 715 to the network device 130. Accordingly, the network device 130 may receive (712) the handover complete message 715 from the terminal device 120. After transmitting (710) the handover complete message 715, the terminal device 120 may transmit (714) an availability indication 725 of the successful handover report 745 to the network device 130. For example, the terminal device 120 can include the availability indication in any RRC message after the handover completion message (such as, the RRCReconfigurationComplete). For example, the availability indication 725 can be carried in the UEAssitanceInformation message.

On the side of the network device 130, after receiving (712) the handover complete message 715, the network device 130 may receive (716) the availability indication 715 from the terminal device 120. Upon receiving (716) the availability indication 715 of the successful handover report 745, the network device 130 may transmit (718) a request message 735 to the terminal device 120. The request message 735 can be used for requesting the successful handover report 745 from the terminal device 120. Upon receiving (720) the request message 735 from the network device 130, the terminal device 120 can transmit (722) the successful handover report 745 to the network device 130. Accordingly, the network device 130 may receive (724) the successful handover report 745 from the terminal device 120.

Through the communication process 700, the terminal device 120 may have one additional reporting chance for the availability of the successful handover report 745 compared to the conventional solutions. In addition, in some embodiments, if the target network device 130 cannot fetch the successful handover report 745 from the terminal device 120, the terminal device 120 can also report the availability of the successful handover report 745 to other cells (or even the same cell 135) by an RRCReconfigurationComplete message, an RRCSetupComplete message, an RRCResumeComplete message, or an RRCReestablishmetComplete message. The cell receiving the successful handover report 745 can obtain an identifier of the source cell (for example, the cell 115) from the successful handover report 745 and may forward the information in the successful handover report 745 to the source cell 115 of the handover event via the interfaces between the network devices.

In some embodiments, the handover of the terminal device 120 from the cell 115 to the cell 135 may be a DAPS handover. In general, a DAPS handover may refer to a handover procedure that maintains the source network device connection after reception of an RRC message for a handover and until releasing the source cell after successful random access to the target network device. In case of the DAPS handover, for RLF in the source cell, any data transmission or reception via the source link may be stopped and the source link may be released, but the source RRC configuration may be maintained.

For example, with reference to FIG. 1A, it is assumed that the handover of the terminal device 120 from the cell 115 to the cell 135 is a DAPS handover. Upon receiving a request to perform the DAPS handover with reduced interruption time, the terminal device 120 may continue to send and receive user data in the source cell 115. At the same time, a new connection 122 to the target cell 135 can be established and the terminal device 120 may perform synchronization and random access in the target cell 135. The terminal device 120 can establish a new user plane protocol stack for the target cell 135, containing PHY (Physical), MAC (Medium Access Control) and RLC (Radio Link Control) layers, while keeping the source user plane protocol stack active for transmission and reception of user data in the source cell 115.

However, the conventional solutions do not consider Rel-16 new features, including the DAPS handover. For example, in case of the DAPS handover, the storing of the information to be included in the successful handover report can happen after the RRCReconfigurationComplete message is generated. This means that it may be impossible to indicate the availability of the successful handover report in the already generated handover completion message. Therefore, in these embodiments, the terminal device 130 can indicate the availability of the successful handover report in a reconfiguration complete message, which reconfiguration complete message is in response to a reconfiguration message causing the terminal device 120 to release the cell 115. Such embodiments will be further described below with reference to FIG. 8.

FIG. 8 illustrates an example communication process 800 among the source network device 110, the target network device 130 and the terminal device 120 in accordance with some embodiments of the present disclosure. For the purpose of discussion, the communication process 800 will be described with reference to FIG. 1A. However, it would be appreciated that the communication process 800 may be similarly applicable to the communication scenarios in FIGS. 1B and 1C as well as any other communication scenarios. In the communication process 800, it is assumed that the report configuration 215 indicates that the successful handover report is to be generated for the handover of the terminal device 120 from the cell 115 to the cell 135. Thus, the terminal device 120 may collect information to be reported in the successful handover report during the performing of the handover. It is further assumed that the handover is a DAPS handover.

As shown in FIG. 8, the network device 110 may transmit (802) a message 805 to the terminal device 120. The message 805 can cause the terminal device 120 to perform the DAPS handover from the cell 115 to the cell 135. For example, the message 805 may be an RRC message for performing a DAPS handover. Upon receiving (804) the message 705 from the network device 110, the terminal device 120 can perform the DAPS handover. If the DAPS handover is completed, the terminal device 120 may generate (806) a message 815 indicating that the DAPS handover is completed. Thus, the message 815 can also be referred to as a handover complete message 815. After generating (806) the message 815, the terminal device 120 may generate (808) the successful handover report 855 of the DAPS handover by storing the collected information in the successful handover report 855. For example, the terminal device 120 may detect that a triggering condition for the successful handover report 855 is satisfied after the generating (806) the message 815.

Then, the terminal device 120 may transmit (810) the handover complete message 815 to the network device 130. Accordingly, the network device 130 may receive (812) the handover complete message 815 from the terminal device 120. Then, the network device 130 may transmit (814) a reconfiguration message 825 to the terminal device 120. The reconfiguration message 825 may cause the terminal device 120 to release the cell 115. The terminal device 120 may receive (816) the reconfiguration message 825 from the network device 130. In response to the reconfiguration message 825, the terminal device 120 may transmit (818) a reconfiguration complete message 835 to the network device 130. The reconfiguration complete message 835 may contain an availability indication of the successful handover report 855 of the DAPS handover. In other words, the terminal device 120 can include the availability indication in an RRC message after the handover completion message 815 (such as, an RRCReconfigurationComplete message). For example, the reconfiguration complete message 835 may be an RRCReconfigurationComplete message in response to an RRCReconfiguration message to release the source cell 115.

The network device 130 may receive (820) the reconfiguration complete message 835 from the terminal device 120. Upon receiving (820) the availability indication in the reconfiguration complete message 835, the network device 130 may transmit (822) a request message 845 to the terminal device 120. The request message 845 can be used for requesting the successful handover report 855 from the terminal device 120. Upon receiving (824) the request message 845 from the network device 130, the terminal device 120 can transmit (826) the successful handover report 855 to the network device 130. Accordingly, the network device 130 may receive (828) the successful handover report 855 from the terminal device 120.

Through the communication process 800, the terminal device 120 may have one additional reporting chance for the availability of the successful handover report 855 of the DAPS handover compared to the conventional solutions. In addition, in some embodiments, if the target network device 130 cannot fetch the successful handover report 855 from the terminal device 120, the terminal device 120 can also report the availability of the successful handover report 855 to other cells (or even the same cell 135) by an RRCReconfigurationComplete message, an RRCSetupComplete message, an RRCResumeComplete message, or an RRCReestablishmetComplete message. The cell receiving the successful handover report 855 can obtain an identifier of the source cell (for example, the cell 115) from the successful handover report 855 and may forward the information in the successful handover report 855 to the source cell 115 of the handover event via the interfaces between the network devices.

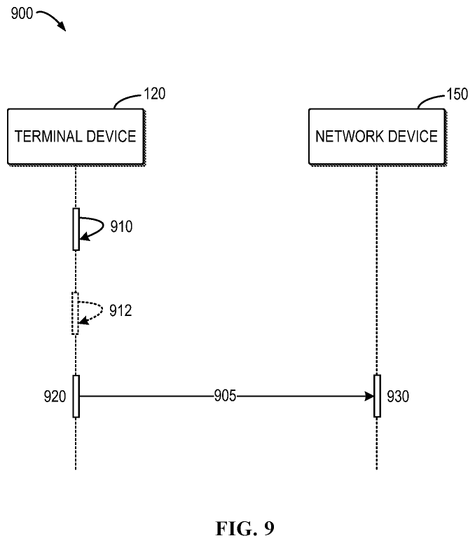

FIG. 9 illustrates an example communication process 900 between the third network device 150 and the terminal device 120 in accordance with some embodiments of the present disclosure. For the purpose of discussion, the communication process 900 will be described with reference to FIG. 1C. However, it would be appreciated that the communication process 900 may be similarly applicable to the communication scenarios in FIGS. 1A and 1B as well as any other communication scenarios. For example, the communication process 900 can be analogously implemented between the terminal device 120 and the target network device 130. In the communication process 900, it is assumed that the report configuration 215 indicates that the successful handover report is to be generated for the handover of the terminal device 120 from the cell 115 to the cell 135. Thus, the terminal device 120 may collect information to be reported in the successful handover report during the performing of the handover.

As shown in FIG. 9, if the terminal device 120 is connected to the cell 155 of the network device 150 after the handover from the cell 115 to the cell 135, the terminal device 120 may determine (910) whether the successful handover report of the handover is stored in the terminal device 120. If the terminal device 120 determines (910) that the successful handover report is stored in the terminal device 120, the terminal device 120 can transmit (920) an availability indication 905 of the successful handover report to the network device 150. Accordingly, the network device 150 may receive (930) the availability indication 905 of the successful handover report from the terminal device 120.

Through the communication process 900, in addition to the target network device 130 of the handover, the network device 150 can also be informed by the terminal device 120 that the successful handover report of the handover is available at the terminal device 120 for the network. Accordingly, the network device 150 can also have an opportunity to fetch the successful handover report from the terminal device 120, thereby enhancing the accessibility of the successful handover report to the network side.

In some embodiments, the terminal device 120 may transmit the availability indication 905 to the network device 150 regardless of whether the cell 155 supports the successful handover report. In other words, there is no need for the terminal device 120 to check if the cell 155 supports successful handover reports. Upon (re)establish or handover to the cell 155 (or any other cell), the terminal device 120 can always report the availability of the successful handover report if the terminal device 120 has stored the collected information to be included in the successful handover report. In this way, the operation complexity of the terminal device 120 for indicating the availability of the successful handover report can be minimized.

Alternatively, in some other embodiments, if the cell 155 does not support successful handover reports, there is no need for the terminal device 120 to report the availability of the successful handover report to the cell 155. Instead, the terminal device 120 can report the availability of the successful handover report in a cell that supports successful handover reports. In other words, the terminal device 120 may only report the availability of the successful handover report to a cell configured with successful handover reports. In this way, the terminal device 120 can avoid transmitting useless information to the network device 150, and can also save the signaling overhead (for example, a bit) for transmitting the useless availability indication. Therefore, in transmitting (920) the availability indication 905, if the terminal device 120 determines (912) that a report configuration of the cell 155 indicates that the cell 155 supports the successful handover report, then the terminal device 120 may transmit (920) the availability indication 905 to the network device 150.

In some embodiments, the terminal device 120 can obtain the report configuration of the cell 155 by checking system information of the cell 155. For example, the terminal device 120 may receive the system information of the cell 155 broadcast by the network device 150. Then, the terminal device 120 may obtain the report configuration of the cell 115 from the received system information. In this way, the terminal device 120 can readily obtain the report configuration of the cell 155 when entering the cell 155, thereby enhancing the availability of the report configuration of the cell 155 for the terminal devices. More specifically; upon (re)establish or handover to the cell 155 (or any other cell), if the system information of the cell 155 contains the report configuration indicating that the successful handover reports are supported in the cell 155, and if the terminal device 120 has stored the information in the successful handover report, then the terminal device 120 can include an availability indication in a message (an RRC message) transmitted to the network device 150.

In some other embodiments, the terminal device 120 can obtain the report configuration of the cell 155 in a message (an RRC message) for causing the terminal device 120 to perform a handover to the cell 155. For example, the target network device 150 in this handover may include the report configuration of the cell 155 in an inter-node message to perform the handover, and send the inter-node message to the source network device in this handover, which may be the network device 130 in FIG. 1C or any other network device. The source network device in this handover may send the message (the RRC message) to the terminal device 120. The message may cause the terminal device 120 to perform the handover and contain the report configuration of the target cell 155.

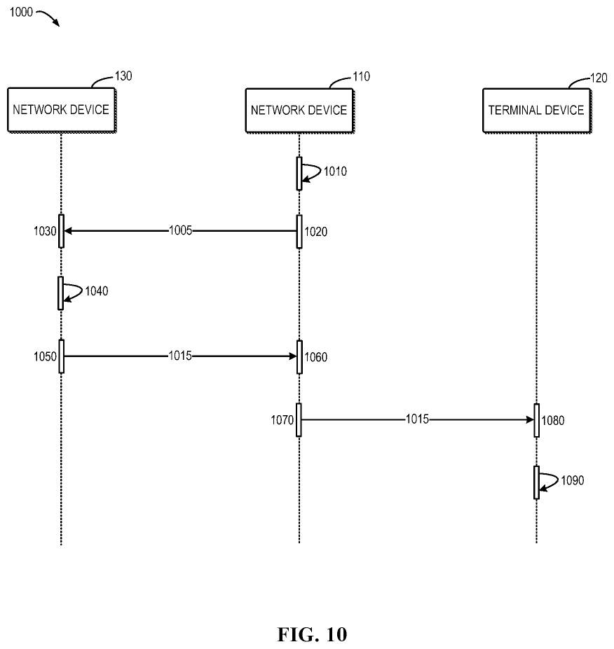

If the terminal device 120 has stored the information in the successful handover report, and if the message causing the terminal device 120 to perform the handover includes the report configuration supporting the successful handover reports, then the terminal device 120 may include an availability indication in another message (for example, another RRC message) transmitted to the network device 150. In this way, the terminal device 120 is enabled to know the report configuration of the target cell 155 earlier compared to the manner in which the report configuration is obtained in the system information of the cell 155. For example, in the system information manner, the terminal device 120 can acquire the system information of the target cell 155 only after reconfiguration with synchronization completion and it may be too late for some cases. Similar embodiments implemented between the network device 110 and the network device 130 will be further described below with reference to FIG. 10.

FIG. 10 illustrates an example communication process 1000 among the source network device 110, the target network device 130 and the terminal device 120 in accordance with some embodiments of the present disclosure. For the purpose of discussion, the communication process 1000 will be described with reference to FIG. 1A or 1C. However, it would be appreciated that the communication process 1000 may be similarly applicable to the communication scenarios in FIG. 1B as well as any other communication scenarios. In the communication process 1000, it is assumed that the report configuration 215 indicates that the successful handover report is to be generated for the handover of the terminal device 120 from the cell 115 to the cell 135. Thus, the terminal device 120 may collect information to be reported in the successful handover report during the performing of the handover.

As shown in FIG. 10, if the network device 110 determines (1010) that the handover of the terminal device 120 from the cell 115 to the cell 135 is to be performed, the network device 110 may transmit (1020) a handover request message 1005 to the network device 130. Upon receiving (1030) the handover request message 1005 from the network device 110, the network device 130 may generate (1040) a handover command message 1015. The handover command message 1015 can be used for causing the terminal device 120 to perform the handover and also for indicating a report configuration of the cell 135. For example, the network device 130 can incorporate the report configuration of the cell 135 into the handover command message 1015. The report configuration of the cell 135 indicates whether the cell 135 supports a successful handover report. After generating (1040) the handover command message 1015, the network device 130 may transmit (1050) the handover command message 1015 to the network device 110. Accordingly, the network device 110 may receive (1060) the handover command message 1015 from the network device 130. Then, the network device 110 can transmit (1070) the handover command message 1015 to the terminal device.

Upon receiving (1080) the handover command message 1015 from the network device 110, the terminal device 120 can obtain (1090) the report configuration of the cell 135 from the handover command message 1015 for causing the terminal device 120 to perform the handover from the cell 115 to the cell 135. Through the communication process 1000, the report configuration of the cell 135 can be included in the handover command message, by taking advantage of the interaction process between the source network device 110 and the target network device 130 for facilitating the handover.

Referring back to FIGS. 1A and 1C, in some embodiments, the network device 110 and the network device 130 in FIG. 1A may be based on different RATs, and the network device 110 and the network device 150 in FIG. 1C may be based on different RATs. In such situations, the reporting of the successful handover report of the handover initiated in the cell 115 to the cell 135 in FIG. 1A and the reporting of the successful handover report of the handover initiated in the cell 115 to the cell 155 in FIG. 1C may be referred to as cross-RAT reporting of the successful handover report. In these embodiments, there may be two opinions for the terminal device 120 to provide the successful handover report to the network, if the successful handover report is available at the terminal device 120.

As a first option, the cross-RAT reporting of the successful handover report may not be supported. In other words, if a source cell of a handover associated with an available successful handover report is based on the NR, if a UE (re-)establish or handover to a LTE cell, and if there is a stored NR successful handover report in the UE, then the UE can keep the stored successful handover report and do not report the availability of the NR successful handover report to the LTE cell. In this way, the impact on the LTE specifications can be avoided. More specifically, in the example scenario shown in FIG. 1C, it is assumed that the cell 115 is based on a first RAT (for example, the NR) and the terminal device 120 is connected to the cell 155 of the network device 150 after the handover from the cell 115 to the cell 135. The terminal device 120 may determine a second RAT of the cell 155. If the second RAT (for example, the LTE) is different from the first RAT (for example, the NR), the terminal device 120 may avoid transmitting an availability indication of the successful handover report to the network device 150, even if the successful handover report is stored in the terminal device 120.

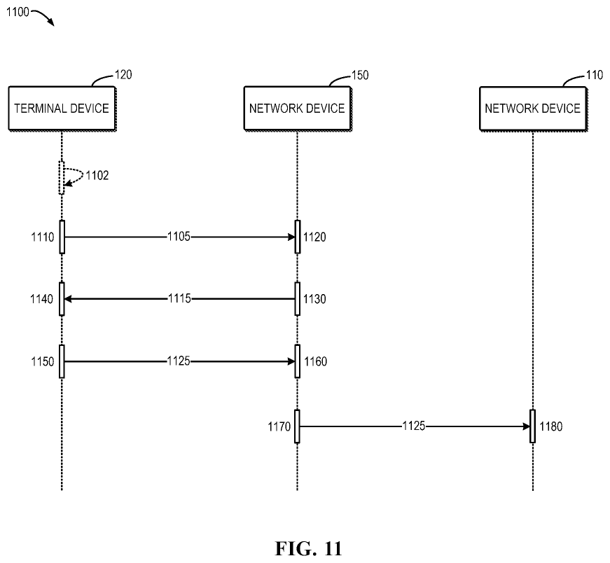

As a second option, the cross-RAT reporting of the successful handover report can be supported. In other words, if a source cell of a handover associated with an available successful handover report is based on the NR, if the UE (re-)establish or handover to a LTE cell, and if there is a stored NR successful handover report in the UE, then the UE may report the availability of the NR successful handover report to the LTE cell. The LTE cell can fetch the NR successful handover report by UEInformationRequest/Respond, and forward the successful handover report to the NR source cell. More specifically, in the example scenario shown in FIG. 1C and in the communication process 900 shown in FIG. 9, the cell 115 of the network device 110 may be based on a first RAT (for example, the NR) and the cell 155 of the network device 150 may be based on a second RAT (for example, the LTE) different from the first RAT (for example, the NR). As such, a shorter delay of the fetching of successful handover reports may be achieved. Such embodiments will be further described below with reference to FIG. 11.

FIG. 11 illustrates an example communication process 1100 among the source network device 110, the third network device 150 and the terminal device 120 the in accordance with some embodiments of the present disclosure. For the purpose of discussion, the communication process 1100 will be described with reference to FIG. 1C. However, it would be appreciated that the communication process 1100 may be similarly applicable to the communication scenarios in FIGS. 1A and 1B as well as any other communication scenarios. For example, the communication process 1100 can be analogously implemented among the source network device 110, the target network device 130 and the terminal device 120.

In the communication process 1100, it is assumed that the report configuration 215 indicates that the successful handover report is to be generated for the handover of the terminal device 120 from the cell 115 to the cell 135. Thus, the terminal device 120 may collect information to be reported in the successful handover report during the performing of the handover. It is further assumed that the network device 110 provides the cell 115 based on a first RAT, and the network device 150 provides the cell 155 based on a second RAT different from the first RAT.

As shown in FIG. 11, the terminal device 120 may transmit (1110) to the network device 150 an availability indication 1105 of the successful handover report 1125 of the handover initiated in the cell 115. After receiving (1120) the availability indication 1105 from the terminal device 120, the network device 150 may transmit (1130) a request message 1115 to the terminal device 120. The request message 1115 is used for requesting the successful handover report 1125 from the terminal device 120. Upon receiving (1140) the request message 1115 from the network device 150, the terminal device 120 may transmit (1150) the successful handover report 1125 to the network device 150.

The network device 150 may receive (1160) the successful handover report 1125 from the terminal device 120. Then, the network device 150 may transmit (1170) the successful handover report 1125 to the network device 110. Accordingly, the network device 110 can receive (1180) the successful handover report 1125 from the network device 150. Through the communication process 1100, cross-RAT reporting of a successful handover report can be supported and thus a shorter delay of the fetching of the successful handover report may be achieved.

In some embodiments, before reporting the availability of a successful handover report, the terminal device 120 may need to check if the reporting of the successful handover report is supported by the cell 155. In this way, if the cell 155 does not support successful handover reports, the signaling overhead (for example, a bit) for transmitting the useless availability indication can be saved. More generally, in transmitting (1110) the availability indication 1105, the terminal device 120 can determine (1102) whether the cell 155 supports the cross-RAT reporting of the successful handover report for the first RAT. If the terminal device 120 determines (1102) that the cell 155 supports the cross-RAT reporting of the successful handover report for the first RAT, then the terminal device 120 can transmit (1110) the availability indication 1105 to the third network device 150.

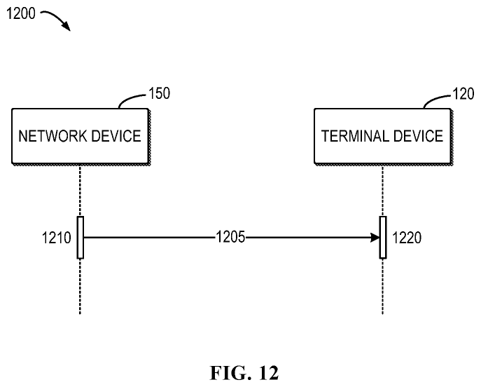

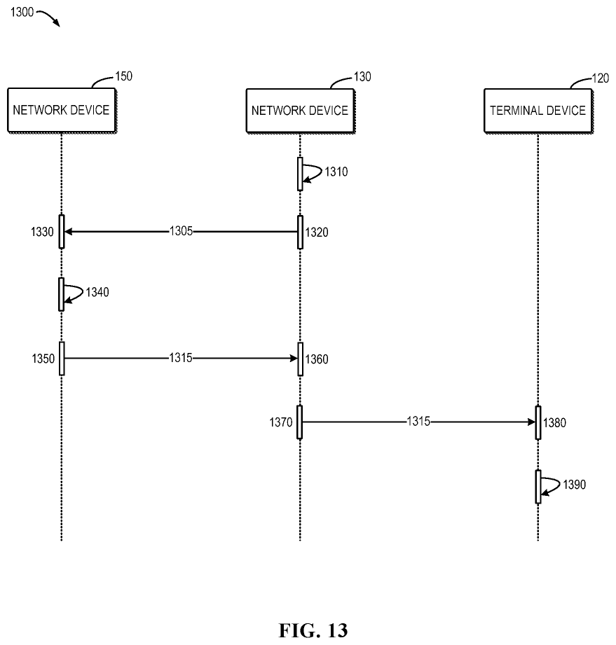

In some embodiments, the network device 150 based on the second RAT can indicate if cross-RAT reporting of successful handover reports is supported by the cell 155 (for example, a LTE cell). In these embodiments, the terminal device 120 may obtain an indication as to whether the cell 155 supports the cross-RAT reporting. As such, the configuration of whether the cross-RAT reporting is supported can be determined and informed by the network device 150 per terminal device. Such embodiments will be further described below with reference to FIGS. 12 and 13.

FIG. 12 illustrates an example communication process 1200 between the third network device 150 and the terminal device 120 in accordance with some embodiments of the present disclosure. For the purpose of discussion, the communication process 1200 will be described with reference to FIG. 1C. However, it would be appreciated that the communication process 1200 may be similarly applicable to the communication scenarios in FIGS. 1A and 1B as well as any other communication scenarios. For example, the communication process 1200 can be analogously implemented between the terminal device 120 and the target network device 130. In the communication process 1200, it is assumed that the network device 110 provides the cell 115 based on a first RAT and the network device 150 provides the cell 155 based on a second RAT different from the first RAT.

As shown in FIG. 12, the network device 150 transmits (1210) an indication 1205 to the terminal device 120. The terminal device 120 previously performed the handover from the cell 115 to the cell 135. The indication is as to whether the cell 155 provided by the network device 150 supports cross-RAT reporting of the successful handover report of the handover. Accordingly, the terminal device 120 may receive (1220) the indication 1205 from the network device 150. In some embodiments, network device 150 may broadcast system information of the cell 155 containing the indication 1205. In these embodiments, the terminal device 120 may receive the indication 1205 from the network device 150 via the system information broadcast by the network device 150. As such, the terminal devices in the cell 155 can obtain the indication 1205 at any time, thereby enhancing the availability of the indication 1205 for the terminal devices. In addition to the system information of the cell 155, the indication 1205 can also be transmitted via a message causing the terminal device 120 to perform a handover to the cell 155. Some embodiments will be further described later with reference to FIG. 13.

Through the communication process 1200, the configuration of whether cross-RAT reporting of a successful handover report is supported can be determined and indicated to the terminal device 120 by the network device 150, and thus the terminal device 120 can avoid informing the availability of the successful handover report to the network device 150 if the cross-RAT reporting is not supported, thereby eliminating the signaling overhead for unnecessary transmission of the availability of the successful handover report. In addition, the network device 150 employing the second RAT different from the first RAT of the source network device 110 can also fetch the successful handover report and forward to the source network device 110, thereby improving the accessibility of the successful handover report to the network.

FIG. 13 illustrates an example communication process 1300 among the target network device 130, the third network device 150 and the terminal device 120 in accordance with some embodiments of the present disclosure. For the purpose of discussion, the communication process 1300 will be described with reference to FIG. 1C. However, it would be appreciated that the communication process 1300 may be similarly applicable to the communication scenarios in FIGS. 1A and 1B as well as any other communication scenarios. For example, the communication process 1300 can be analogously implemented among the source network device 110, the target network device 130, and the terminal device 120.

In the communication process 1300, it is assumed that the network device 110 provides the cell 115 based on a first RAT and the network device 150 provides the cell 155 based on a second RAT different from the first RAT. It is also assumed that the terminal device 120 needs to perform a handover from the cell 135 to the cell 155. However, it is noted that the communication process 1300 can be similarly applied to any handover of the terminal device 120 from any cell to the cell 155.

As shown in FIG. 13, upon determining (1310) that the terminal device 120 needs to perform a handover from the cell 135 to the cell 155, the network device 130 may transmit (1320) a handover request message 1305 to the network device 150. Upon receiving (1330) the handover request message 1305 from the network device 130, the network device 150 may generate (1340) a handover command message 1315. The handover command message 1315 can cause the terminal device 120 to perform the handover from the cell 135 to the third cell 155. In addition, the handover command message 1315 may contain the indication as to whether the cell 155 provided by the network device 150 supports cross-RAT reporting of successful handover reports.

Then, the network device 150 may transmit (1350) the handover command message 1315 to a serving network device (for example, the network device 130) of the terminal device 120. After receiving (1360) the handover command message 1315 from the network device 150, the serving network device (for example, the network device 130) can transmit (1370) the handover command message 1315 to the terminal device 120. Upon receiving (1380) the handover command message 1315 from the serving network device (for example, the network device 130), the terminal device 120 may obtain (1390) the indication from the handover command message 1315.

Through the communication process 1300, the configuration of whether cross-RAT reporting of a successful handover report is supported can be determined and indicated to the terminal device 120, and thus the terminal device 120 can avoid informing the availability of the successful handover report to the network device 150 if the cross-RAT reporting is not supported, thereby eliminating the signaling overhead for unnecessary transmission of the availability of the successful handover report. In addition, the network device 150 employing the second RAT different from the first RAT of the source network device 110 can also fetch the successful handover report and forward to the source network device 110, thereby improving the accessibility of the successful handover report to the network. Further, the indication can be included in the handover command message, by taking advantage of the interaction process between two network devices for facilitating the handover.

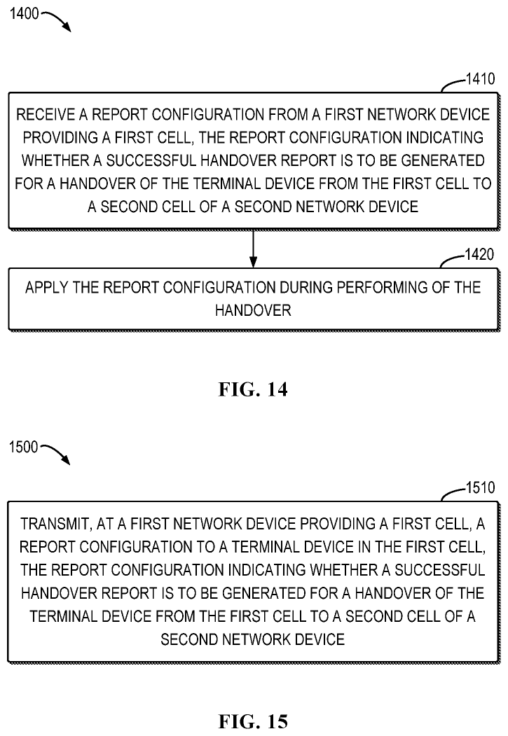

FIG. 14 illustrates a flowchart of an example method 1400 in accordance with some embodiments of the present disclosure. In some embodiments, the method 1400 can be implemented at a terminal device, such as the terminal device 120 as shown in FIGS. 1A, 1B and 1C. Additionally or alternatively, the method 1400 can also be implemented at other terminal devices not shown in FIGS. 1A, 1B and 1C. For the purpose of discussion, the method 1400 will be described with reference to FIGS. 1A, 1B and 1C as being performed by the terminal device 120 without loss of generality.

At block 1410, the terminal device 120 receives a report configuration from the first network device 110 providing the first cell 115. The report configuration indicates whether a successful handover report is to be generated for a handover of the terminal device 120 from the first cell 115 to the second cell 135 of the second network device 130. At block 1420, the terminal device 120 applies the report configuration during performing of the handover.

In some embodiments, the report configuration may be carried in at least one of the following: system information of the first cell 115 broadcast by the first network device 110, a first message causing the terminal device 120 to perform the handover, and a second message specific to the terminal device 120 received prior to the initiation of the handover.

In some embodiments, in receiving the report configuration, the terminal device 120 can receive, via the system information, a first candidate report configuration with a first priority. The terminal device 120 can receive, via the first message or the second message, a second candidate report configuration with a second priority. If the second priority is higher than the first priority, the terminal device 120 can determine the second candidate report configuration as the report configuration.

In some embodiments, in receiving the report configuration, the terminal device 120 can receive a first part of the report configuration via the system information, and receive a second part of the report configuration via the first message or the second message.

In some embodiments, if the handover is completed, the terminal device 120 may release the report configuration.

In some embodiments, if the handover is failed, the terminal device 120 may reestablish a connection to an available cell and release the report configuration.

In some embodiments, the report configuration may comprise at least one of the following: an indication that the successful handover report is to be generated, and a triggering condition for triggering the successful handover report to be generated.

In some embodiments, in applying the report configuration, if the successful handover report is to be generated, the terminal device 120 may collect information to be reported in the successful handover report during the performing of the handover.

In some embodiments, in applying the report configuration, if the successful handover report is not to be generated, the terminal device 120 may avoid collecting information for the successful handover report during the performing of the handover.

In some embodiments, the terminal device 120 can transmit an availability indication of the successful handover report to the second network device 130, after a handover complete message indicating that the handover is completed is transmitted to the second network device 130.

In some embodiments, the handover may be a DAPS handover. The terminal device 120 can transmit, to the second network device 130, a handover complete message indicating that the handover is completed. The terminal device 120 can receive, from the second network device 130, a reconfiguration message causing the terminal device 120 to release the first cell 115. The terminal device 120 can transmit, to the second network device 130, a reconfiguration complete message containing an availability indication of the successful handover report.

In some embodiments, if the terminal device 120 is connected to a third cell 155 of the third network device 150 after the handover, the terminal device 120 may determine whether the successful handover report is stored in the terminal device 120. If the successful handover report is stored in the terminal device 120, the terminal device 120 may transmit an availability indication of the successful handover report to the third network device 150.

In some embodiments, in transmitting the availability indication, the terminal device 120 may transmit the availability indication to the third network device 150 regardless of whether the third cell 155 supports the successful handover report.

In some embodiments, the report configuration may be a first report configuration. In transmitting the availability indication, if a second report configuration of the third cell 155 indicates that the third cell 155 supports the successful handover report, the terminal device 120 can transmit the availability indication to the third network device 150.

In some embodiments, the terminal device 120 can receive system information of the third cell 155 broadcast by the third network device 150, and obtain the second report configuration from the received system information.

In some embodiments, the terminal device 120 may obtain the second report configuration from a message causing the terminal device 120 to perform the handover.

In some embodiments, the first cell 115 may be based on a first RAT and the third cell 155 may be based on a second RAT different from the first RAT.

In some embodiments, in transmitting the availability indication, if the third cell 155 supports cross-RAT reporting of the successful handover report for the first RAT, the terminal device 120 may transmit the availability indication to the third network device 150.

In some embodiments, the terminal device 120 may obtain an indication as to whether the third cell 155 supports the cross-RAT reporting.

In some embodiments, in obtaining the indication, the terminal device 120 may receive the indication from the third network device 150 via system information of the third cell 155 broadcast by the third network device 150; and/or obtain the indication from a message causing the terminal device 120 to perform a handover to the third cell 155.

In some embodiments, the first cell 115 may be based on a first RAT. If the terminal device 120 is connected to a third cell 155 of a third network device 150 after the handover, the terminal device 120 may determine a second RAT of the third cell 155. If the second RAT is different from the first RAT, the terminal device 120 may avoid transmitting an availability indication of the successful handover report to the third network device 150, even if the successful handover report is stored in the terminal device 120.

In some embodiments, if the handover is failed, the terminal device 120 can discard the collected information.

FIG. 15 illustrates a flowchart of an example method 1500 in accordance with some embodiments of the present disclosure. In some embodiments, the method 1500 can be implemented at a network device, such as the network device 110 as shown in FIGS. 1A, 1B and 1C. Additionally or alternatively, the method 1500 can also be implemented at other network devices not shown in FIGS. 1A, 1B and 1C. For the purpose of discussion, the method 1500 will be described with reference to FIGS. 1A, 1B and 1C as being performed by the network device 110 without loss of generality.

At block 1510, the first network device 110 provides the first cell 115 and transmits a report configuration to the terminal device 120 in the first cell 115. The report configuration indicates whether a successful handover report is to be generated for a handover of the terminal device 120 from the first cell 115 to the second cell 135 of the second network device 130.

In some embodiments, in transmitting the report configuration, the first network device 110 may broadcast system information of the first cell 115 for indicating the report configuration.

In some embodiments, in transmitting the report configuration, the first network device 110 may transmit a first message for causing the terminal device 120 to perform the handover and for indicating the report configuration.

In some embodiments, if the handover is to be performed, the first network device 110 can transmit a handover request message containing the report configuration to the second network device 130 and receive the first message from the second network device 130.

In some embodiments, if the handover is to be performed, the first network device 110 may transmit a handover request message to the second network device 130. The first network device 110 may receive, from the second network device 130, a handover command message for causing the terminal device 120 to perform the handover. The first network device 110 may generate the first message by incorporating the report configuration and the handover command message into the first message.

In some embodiments, in transmitting the report configuration, the first network device 110 can transmit a second message specific to the terminal device 120 for indicating the report configuration, prior to a handover command message causing the terminal device 120 to perform the handover is transmitted to the terminal device 120.

In some embodiments, the first network device 110 may determine a first candidate report configuration with a first priority; and determine a second candidate report configuration with a second priority higher than the first priority.

In some embodiments, in transmitting the report configuration, the first network device 110 may broadcast system information of the first cell 115 for indicating the first candidate report configuration. The first network device 110 can transmit, to the terminal device 120, a first message for causing the terminal device 120 to perform the handover and for indicating the second candidate report configuration, or a second message specific to the terminal device 120 for indicating the second candidate report configuration prior to a handover command message for causing the terminal device 120 to perform the handover is transmitted to the terminal device 120.

In some embodiments, the first network device 110 may determine a first part of the report configuration and determine a second part of the report configuration.

In some embodiments, in transmitting the report configuration, the first network device 110 can broadcast system information of the first cell 115 for indicating the first part of the report configuration. The first network device 110 may transmit, to the terminal device 120, a first message for causing the terminal device 120 to perform the handover and for indicating the second part of the report configuration, or a second message specific to the terminal device 120 for indicating the second part of the report configuration prior to a handover command message for causing the terminal device 120 to perform the handover is transmitted to the terminal device 120.

In some embodiments, the report configuration may be a first report configuration. If the handover is to be performed, the first network device 110 may transmit a handover request message to the second network device 130. The first network device 110 may receive, from the second network device 130, a handover command message for causing the terminal device 120 to perform the handover and for indicating a second report configuration of the second cell 135, the second report configuration indicating whether the second cell 135 supports the successful handover report. The first network device 110 can transmit the handover command message to the terminal device 120.

In some embodiments, the report configuration may comprise at least one of the following: an indication that the successful handover report is to be generated, and a triggering condition for triggering the successful handover report to be generated.

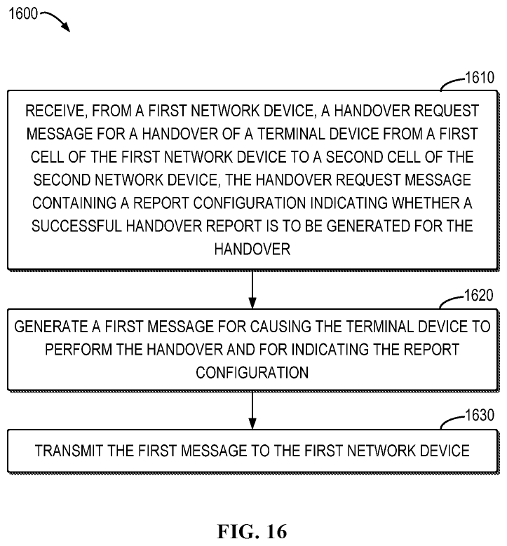

FIG. 16 illustrates a flowchart of an example method 1600 in accordance with some embodiments of the present disclosure. In some embodiments, the method 1600 can be implemented at a network device, such as the network device 130 as shown in FIG. 1A or 1C. Additionally or alternatively, the method 1600 can also be implemented at other network devices not shown in FIGS. 1A, 1B and 1C. For the purpose of discussion, the method 1600 will be described with reference to FIG. 1A or 1C as being performed by the network device 130 without loss of generality.

At block 1610, the second network device 130 receives a handover request message from the first network device 110. The handover request message is for a handover of the terminal device 120 from the first cell 115 of the first network device 110 to the second cell 135 of the second network device 130. The handover request message contains a report configuration indicating whether a successful handover report is to be generated for the handover. At block 1620, the second network device 130 generates a first message for causing the terminal device 120 to perform the handover and for indicating the report configuration. At block 1630, the second network device 130 transmits the first message to the first network device 110.

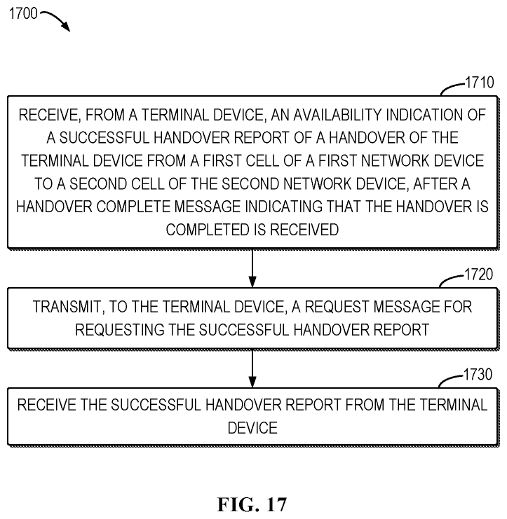

FIG. 17 illustrates a flowchart of an example method 1700 in accordance with some embodiments of the present disclosure. In some embodiments, the method 1700 can be implemented at a network device, such as the network device 130 as shown in FIG. 1A or 1C. Additionally or alternatively, the method 1700 can also be implemented at other network devices not shown in FIGS. 1A, 1B and 1C. For the purpose of discussion, the method 1700 will be described with reference to FIG. 1A or 1C as being performed by the network device 130 without loss of generality.

At block 1710, the second network device 130 receives, from the terminal device 120, an availability indication of a successful handover report of a handover of the terminal device 120 from the first cell 115 of the first network device 110 to the second cell 135 of the second network device 130, after a handover complete message indicating that the handover is completed is received. At block 1720, the second network device 130 transmits a request message to the terminal device 120. The request message is for requesting the successful handover report. At block 1730, the second network device 130 receives the successful handover report from the terminal device 120.

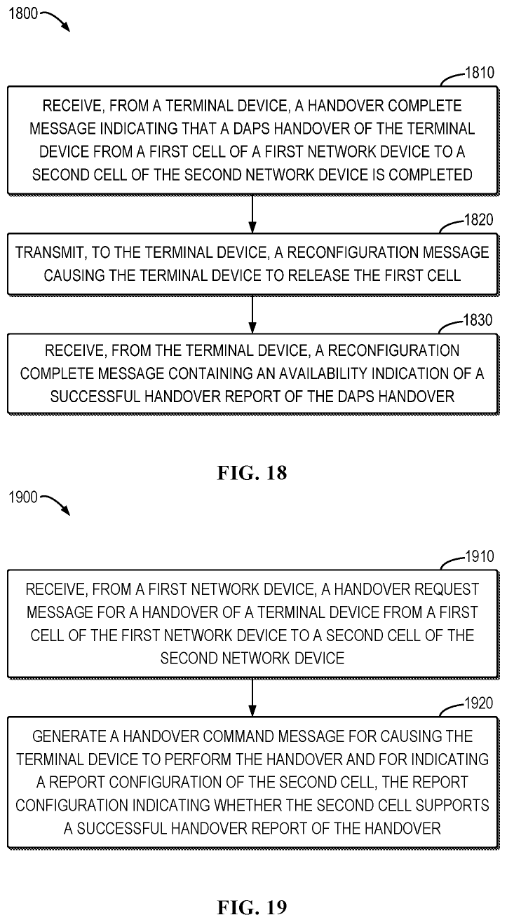

FIG. 18 illustrates a flowchart of an example method 1800 in accordance with some embodiments of the present disclosure. In some embodiments, the method 1800 can be implemented at a network device, such as the network device 130 as shown in FIG. 1A or 1C. Additionally or alternatively, the method 1800 can also be implemented at other network devices not shown in FIGS. 1A, 1B and 1C. For the purpose of discussion, the method 1800 will be described with reference to FIG. 1A or 1C as being performed by the network device 130 without loss of generality.

At block 1810, the second network device 130 receives a handover complete message from the terminal device 120. The handover complete message indicates that a DAPS handover of the terminal device 120 from the first cell 115 of the first network device 110 to the second cell 135 of the second network device 130 is completed. At block 1820, the second network device 130 transmits a reconfiguration message to the terminal device 120. The reconfiguration message causes the terminal device 120 to release the first cell 115. At block 1830, the second network device 130 receives a reconfiguration complete message from the terminal device 120. The reconfiguration complete message contains an availability indication of a successful handover report of the DAPS handover.

FIG. 19 illustrates a flowchart of an example method 1900 in accordance with some embodiments of the present disclosure. In some embodiments, the method 1900 can be implemented at a network device, such as the network device 130 as shown in FIG. 1A or 1C. Additionally or alternatively, the method 1900 can also be implemented at other network devices not shown in FIGS. 1A, 1B and 1C. For the purpose of discussion, the method 1900 will be described with reference to FIG. 1A or 1C as being performed by the network device 130 without loss of generality.

At block 1910, the second network device 130 receives a handover request message from the first network device 110. The handover request message is for a handover of the terminal device 120 from the first cell 115 of the first network device 110 to the second cell 135 of the second network device 130. At block 1920, the second network device 130 generates a handover command message for causing the terminal device 120 to perform the handover and for indicating a report configuration of the second cell 135. The report configuration indicates whether the second cell 135 supports a successful handover report of the handover.

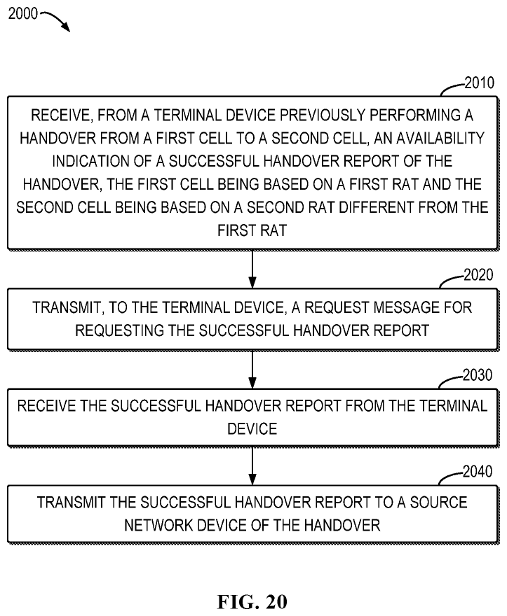

FIG. 20 illustrates a flowchart of an example method 2000 in accordance with some embodiments of the present disclosure. In some embodiments, the method 2000 can be implemented at a network device, such as the network device 130 or the network device 150 as shown in FIG. 1A or 1C. Additionally or alternatively, the method 2000 can also be implemented at other network devices not shown in FIGS. 1A, 1B and 1C. For the purpose of discussion, the method 2000 will be described with reference to FIG. 1C as being performed by the network device 150 (or the network device 130) without loss of generality.

At block 2010, the third network device 150 (or the network device 130) receives, from the terminal device 120 previously performing a handover from the first cell 115 to the second cell 135, an availability indication of a successful handover report of the handover. The first cell 115 is based on a first RAT and the third cell 155 (or the second cell 135) is based on a second RAT different from the first RAT. At block 2020, the third network device 150 (or the network device 130) transmits a request message to the terminal device 120. The request message is for requesting the successful handover report. At block 2030, the third network device 150 (or the network device 130) receives the successful handover report from the terminal device 120. At block 2040, the third network device 150 (or the network device 130) transmits the successful handover report to the source network device 110 of the handover.

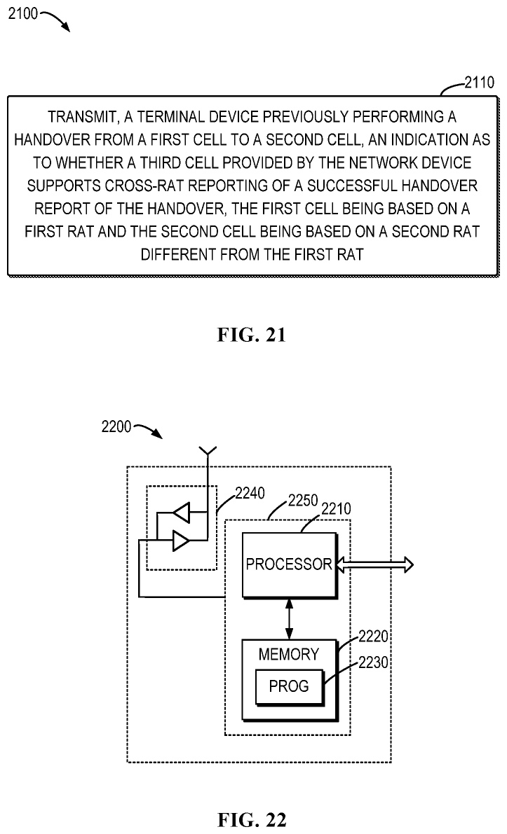

FIG. 21 illustrates a flowchart of an example method 2100 in accordance with some embodiments of the present disclosure. In some embodiments, the method 2100 can be implemented at a network device, such as the network device 130 or the network device 150 as shown in FIG. 1A or 1C. Additionally or alternatively, the method 2100 can also be implemented at other network devices not shown in FIGS. 1A, 1B and 1C. For the purpose of discussion, the method 2100 will be described with reference to FIG. 1C as being performed by the network device 150 (or the network device 130) without loss of generality.

At block 2110, the third network device 150 (or the network device 130) transmits an indication to the terminal device 120 previously performing a handover from the first cell 115 to the second cell 135. The indication is as to whether the third cell 155 (or the second cell 135) provided by the network device 150 (or the network device 130) supports cross-RAT reporting of a successful handover report of the handover. The first cell 115 is based on a first RAT and the third cell 155 (or the second cell 135) is based on a second RAT different from the first RAT.

In some embodiments, the handover may be a first handover. In transmitting the indication, the third network device 150 (or the network device 130) may generate a handover command message causing the terminal device 120 to perform a second handover to the third cell 155 (or the first handover) and containing the indication. The third network device 150 (or the network device 130) can transmit the handover command message to a serving network device of the terminal device 120 (or the first network device 110), such that the serving network device (or the first network device 110) transmits the handover command message to the terminal device 120.

In some embodiments, in transmitting the indication, the third network device 150 (or the network device 130) may broadcast system information of the third cell 155 (or the second cell 135) containing the indication.

According to embodiments of the present disclosure, a terminal device comprises circuitry configured to: receive a report configuration from a first network device providing a first cell, the report configuration indicating whether a successful handover report is to be generated for a handover of the terminal device from the first cell to a second cell of a second network device; and apply the report configuration during performing of the handover.

In some embodiments, the report configuration may be carried in at least one of the following: system information of the first cell broadcast by the first network device, a first message causing the terminal device to perform the handover, and a second message specific to the terminal device received prior to the initiation of the handover.

In some embodiments, in receiving the report configuration, the circuitry may be configured to: receive, via the system information, a first candidate report configuration with a first priority; receive, via the first message or the second message, a second candidate report configuration with a second priority; and if the second priority is higher than the first priority, determine the second candidate report configuration as the report configuration.

In some embodiments, in receiving the report configuration, the circuitry may be configured to: receive a first part of the report configuration via the system information; and receive a second part of the report configuration via the first message or the second message.

In some embodiments, the circuitry may be further configured to: if the handover is completed, releasing the report configuration.

In some embodiments, the circuitry may be further configured to: if the handover is failed, reestablishing a connection to an available cell; and release the report configuration.

In some embodiments, the report configuration may comprise at least one of the following: an indication that the successful handover report is to be generated, and a triggering condition for triggering the successful handover report to be generated.

In some embodiments, in applying the report configuration, the circuitry may be configured to: if the successful handover report is to be generated, collect information to be reported in the successful handover report during the performing of the handover.

In some embodiments, in applying the report configuration, the circuitry may be configured to: if the successful handover report is not to be generated, avoid collecting information for the successful handover report during the performing of the handover.

In some embodiments, the circuitry may be further configured to: transmit an availability indication of the successful handover report to the second network device, after a handover complete message indicating that the handover is completed is transmitted to the second network device.

In some embodiments, the handover may be a DAPS handover and the circuitry may be further configured to: transmit, to the second network device, a handover complete message indicating that the handover is completed; receive, from the second network device, a reconfiguration message causing the terminal device to release the first cell; and transmit, to the second network device, a reconfiguration complete message containing an availability indication of the successful handover report.

In some embodiments, the circuitry may be further configured to: if the terminal device is connected to a third cell of a third network device after the handover, determine whether the successful handover report is stored in the terminal device; and if the successful handover report is stored in the terminal device, transmit an availability indication of the successful handover report to the third network device.

In some embodiments, in transmitting the availability indication, the circuitry may be configured to: transmit the availability indication to the third network device regardless of whether the third cell supports the successful handover report.

In some embodiments, the report configuration may be a first report configuration and in transmitting the availability indication, the circuitry may be configured to: if a second report configuration of the third cell indicates that the third cell supports the successful handover report, transmit the availability indication to the third network device.

In some embodiments, the circuitry may be further configured to: receive system information of the third cell broadcast by the third network device; and obtain the second report configuration from the received system information.

In some embodiments, the circuitry may be further configured to: obtain the second report configuration from a message causing the terminal device to perform the handover.

In some embodiments, the first cell can be based on a first RAT and the third cell can be based on a second RAT different from the first RAT.

In some embodiments, in transmitting the availability indication, the circuitry may be configured to: if the third cell supports cross-RAT reporting of the successful handover report for the first RAT, transmit the availability indication to the third network device.

In some embodiments, the circuitry may be further configured to: obtain an indication as to whether the third cell supports the cross-RAT reporting.

In some embodiments, in obtaining the indication, the circuitry may be configured to at least one of the following: receive the indication from the third network device via system information of the third cell broadcast by the third network device; and obtain the indication from a message causing the terminal device to perform a handover to the third cell.

In some embodiments, the first cell may be based on a first RAT and the circuitry may be further configured to: if the terminal device is connected to a third cell of a third network device after the handover, determine a second RAT of the third cell; and if the second RAT is different from the first RAT, avoid transmitting an availability indication of the successful handover report to the third network device, even if the successful handover report is stored in the terminal device.

In some embodiments, the circuitry may be further configured to: if the handover is failed, discard the collected information.

According to embodiments of the present disclosure, a first network device comprises circuitry configured to: transmit, at the first network device providing a first cell, a report configuration to a terminal device in the first cell, the report configuration indicating whether a successful handover report is to be generated for a handover of the terminal device from the first cell to a second cell of a second network device.

In some embodiments, in transmitting the report configuration, the circuitry may be configured to: broadcast system information of the first cell for indicating the report configuration.

In some embodiments, in transmitting the report configuration, the circuitry may be configured to: transmit a first message for causing the terminal device to perform the handover and for indicating the report configuration.

In some embodiments, the circuitry may be further configured to: if the handover is to be performed, transmit a handover request message containing the report configuration to the second network device; and receive the first message from the second network device.

In some embodiments, the circuitry may be further configured to: if the handover is to be performed, transmit a handover request message to the second network device; receive, from the second network device, a handover command message for causing the terminal device to perform the handover; and generate the first message by incorporating the report configuration and the handover command message into the first message.

In some embodiments, in transmitting the report configuration, the circuitry may be configured to: transmit a second message specific to the terminal device for indicating the report configuration, prior to a handover command message causing the terminal device to perform the handover is transmitted to the terminal device.

In some embodiments, the circuitry may be further configured to: determine a first candidate report configuration with a first priority; and determine a second candidate report configuration with a second priority higher than the first priority.

In some embodiments, in transmitting the report configuration, the circuitry may be configured to: broadcast system information of the first cell for indicating the first candidate report configuration; and transmit, to the terminal device, a first message for causing the terminal device to perform the handover and for indicating the second candidate report configuration, or a second message specific to the terminal device for indicating the second candidate report configuration prior to a handover command message for causing the terminal device to perform the handover is transmitted to the terminal device.

In some embodiments, the circuitry may be further configured to: determine a first part of the report configuration; and determine a second part of the report configuration.

In some embodiments, in transmitting the report configuration, the circuitry may be configured to: broadcast system information of the first cell for indicating the first part of the report configuration; and transmit, to the terminal device, a first message for causing the terminal device to perform the handover and for indicating the second part of the report configuration, or a second message specific to the terminal device for indicating the second part of the report configuration prior to a handover command message for causing the terminal device to perform the handover is transmitted to the terminal device.

In some embodiments, the report configuration may be a first report configuration and the circuitry may be further configured to: if the handover is to be performed, transmit a handover request message to the second network device; receive, from the second network device, a handover command message for causing the terminal device to perform the handover and for indicating a second report configuration of the second cell, the second report configuration indicating whether the second cell supports the successful handover report; and transmit the handover command message to the terminal device.

In some embodiments, the report configuration can comprise at least one of the following: an indication that the successful handover report is to be generated, and a triggering condition for triggering the successful handover report to be generated.

According to embodiments of the present disclosure, a second network device comprises circuitry configured to: receive, from a first network device, a handover request message for a handover of a terminal device from a first cell of the first network device to a second cell of the second network device, the handover request message containing a report configuration indicating whether a successful handover report is to be generated for the handover; generate a first message for causing the terminal device to perform the handover and for indicating the report configuration; and transmit the first message to the first network device.

According to embodiments of the present disclosure, a second network device comprises circuitry configured to: receive, from a terminal device, an availability indication of a successful handover report of a handover of the terminal device from a first cell of a first network device to a second cell of the second network device, after a handover complete message indicating that the handover is completed is received; transmit, to the terminal device, a request message for requesting the successful handover report; and receive the successful handover report from the terminal device.

According to embodiments of the present disclosure, a second network device comprises circuitry configured to: receive, from a terminal device, a handover complete message indicating that a DAPS handover of the terminal device from a first cell of a first network device to a second cell of the second network device is completed; transmit, to the terminal device, a reconfiguration message causing the terminal device to release the first cell; and receive, from the terminal device, a reconfiguration complete message containing an availability indication of a successful handover report of the DAPS handover.

According to embodiments of the present disclosure, a second network device comprises circuitry configured to: receive, from a first network device, a handover request message for a handover of a terminal device from a first cell of the first network device to a second cell of the second network device; and generate a handover command message for causing the terminal device to perform the handover and for indicating a report configuration of the second cell, the report configuration indicating whether the second cell supports a successful handover report of the handover.

According to embodiments of the present disclosure, a network device comprises circuitry configured to: receive, from a terminal device previously performing a handover from a first cell to a second cell, an availability indication of a successful handover report of the handover, the first cell being based on a first radio access technology (RAT) and a third cell provided by the network device being based on a second RAT different from the first RAT; transmit, to the terminal device, a request message for requesting the successful handover report; receive the successful handover report from the terminal device; and transmit the successful handover report to a source network device of the handover.

According to embodiments of the present disclosure, a network device comprises circuitry configured to: transmit, to a terminal device previously performing a handover from a first cell to a second cell, an indication as to whether a third cell provided by the network device supports cross-RAT reporting of a successful handover report of the handover, the first cell being based on a first radio access technology (RAT) and the third cell being based on a second RAT different from the first RAT.

In some embodiments, the handover may be a first handover, and in transmitting the indication, the circuitry may be configured to: generate a handover command message causing the terminal device to perform a second handover to the third cell and containing the indication; and transmit the handover command message to a serving network device of the terminal device, such that the serving network device transmits the handover command message to the terminal device.

In some embodiments, in transmitting the indication, the circuitry may be configured to: broadcast system information of the third cell containing the indication.

FIG. 22 is a simplified block diagram of a device 2200 that is suitable for implementing some embodiments of the present disclosure. The device 2200 can be considered as a further embodiment of the network device 110, the terminal device 120, the network device 130, and the network device 150 as shown in FIGS. 1A, 1B, and 1C. Accordingly, the device 2200 can be implemented at or as at least a part of the network device 110, the terminal device 120, the network device 130, and the network device 150.

As shown, the device 2200 includes a processor 2210, a memory 2220 coupled to the processor 2210, a suitable transmitter (TX) and receiver (RX) 2240 coupled to the processor 2210, and a communication interface coupled to the TX/RX 2240. The memory 2220 stores at least a part of a program 2230. The TX/RX 2240 is for bidirectional communications. The TX/RX 2240 has at least one antenna to facilitate communication, though in practice an Access Node mentioned in this application may have several ones. The communication interface may represent any interface that is necessary for communication with other network elements, such as X2 or Xn interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 2230 is assumed to include program instructions that, when executed by the associated processor 2210, enable the device 2200 to operate in accordance with the embodiments of the present disclosure, as discussed herein with reference to any of FIGS. 14 to 21. The embodiments herein may be implemented by computer software executable by the processor 2210 of the device 2200, or by hardware, or by a combination of software and hardware. The processor 2210 may be configured to implement various embodiments of the present disclosure. Furthermore, a combination of the processor 2210 and memory 2220 may form processing means 2250 adapted to implement various embodiments of the present disclosure.

The memory 2220 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory; as non-limiting examples. While only one memory 2220 is shown in the device 2200, there may be several physically distinct memory modules in the device 2200. The processor 2210 may be of any type suitable to the local technical network, and may include one or more of general purpose computers, special purpose computers, microprocessors, digital signal processors (DSPs) and processors based on multicore processor architecture, as non-limiting examples. The device 2200 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In some embodiments, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of the figures. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-50. (canceled)

51. A method for a terminal device, comprising:
receiving, from a first network device, a report configuration,
wherein
the report configuration indicates whether the terminal device generates a successful handover report for a handover of the terminal device to a target cell of a second network device; and
determining a content included in the variable for the successful handover report in a case where the report configuration indicates the terminal device generates the successful handover report.

52. The method of claim 51, wherein the report configuration is carried in at least one of the following:
system information of a cell broadcasted by the first network device,
a first message causing the terminal device to perform the handover, and
a second message specific to the terminal device received prior to a initiation of the handover.

53. The method of claim 52,
the second message is an RRC message.

54. The method of claim 53,
the RRC message is an RRCReconfiguration message.

55. The method of claim 51,
storing a successful handover information in the variable for the successful handover report.

56. The method of claim 51,
discarding the variable for the successful handover report
after setting the successful handover report in a message for the first network device or the second network device.

57. The method of claim 56,
discarding the successful handover report 48 hours after storing the successful handover report.

58. The method of claim 51,
releasing the report configuration on a successful handover.

59. The method of claim 51,
releasing the report configuration on an RRC reestablishment procedure.

60. The method of claim 51,
sending, to the first network device or the second network device, a third message including availability of the successful handover report.

61. The method of claim 60,
the third message is an RRC message.

62. The method of claim 61,
the third message is RRCReconfigurationComplete message, RRCSetupComplete message, RRCResumeComplete message, or RRCReestablishmentComplete message.

63. A method for a first network device, comprising:
sending, to a terminal device, a report configuration,
wherein
the report configuration indicates whether the terminal device generates a successful handover report for a handover of the terminal device to a target cell of a second network device; and
determining a content included in the variable for the successful handover report in a case where the report configuration indicates the terminal device generates the successful handover report.

64. The method of claim 63, wherein the report configuration is carried in at least one of the following:
system information of a cell broadcasted by the first network device,
a first message causing the terminal device to perform the handover, and
a second message specific to the terminal device received prior to a initiation of the handover.

65. The method of claim 64,
the second message is an RRC message.

66. The method of claim 65,
the RRC message is an RRCReconfiguration message.

67. The method of claim 63,
storing a successful handover information in the variable for the successful handover report.

68. The method of claim 63,
discarding the variable for the successful handover report
after setting the successful handover report in a message for the first network device or the second network device.

69. The method of claim 68,
discarding the successful handover report 48 hours after storing the successful handover report.

70. The method of claim 63,
releasing the report configuration on a successful handover.

71. The method of claim 63,
releasing the report configuration on an RRC reestablishment procedure.

72. The method of claim 63,
sending, to the first network device or the second network device, a third message including availability of the successful handover report.

73. The method of claim 72,
the third message is an RRC message.

74. The method of claim 73,
the third message is RRCReconfigurationComplete message, RRCSetupComplete message, RRCResumeComplete message, or RRCReestablishmentComplete message.
